(19) United States
(12) Patent Application Publication
(10) Pub. No.: US 2007/0109368 A1
(43) Pub. Date: May 17, 2007

(54) LIQUID CONTAINER AND LIQUID FILLING METHOD

(76) Inventor: Hitotoshi Kimura, Matsumoto-shi (JP)

Correspondence Address: STROOCK & STROOCK & LAVAN LLP, 180 MAIDEN LANE, NEW YORK, NY, 10038, US

(21) Appl. No.: 11/557,380

(22) Filed: Nov. 7, 2006

(30) Foreign Application Priority Data
Nov. 8, 2005 (JP) P2005-323977
Nov. 30, 2005 (JP) P2005-347091
Dec. 7, 2005 (JP) P2005-353111
Aug. 8, 2006 (JP) P2006-215220

(51) Int. Cl. B41J 2/175

(52) U.S. Cl. 347/86; 347/85

(57) ABSTRACT

A liquid container includes: a liquid containing portion that is pressurized by a pressure unit and discharges a liquid stored therein through a liquid discharge port; a liquid supply port that supplies the liquid to an external liquid consuming apparatus; and a liquid detection unit that is interposed between the liquid containing portion and the liquid supply port, wherein the liquid detection unit includes: a liquid detection chamber that has a liquid inlet port to be connected to the liquid discharge port of the liquid containing portion and a liquid outlet port to be connected to the liquid supply port; a movable member that is movably accommodated in response to a liquid containing amount of the liquid detection chamber; a recess portion that partitions a detection space in cooperation with one surface of the movable member when the liquid containing amount of the liquid detection chamber becomes a predetermined amount or lesser and a piezoelectric detection unit that applies vibration to the recess portion and detects a free vibration state according to the applied vibration, and wherein the movable member is provided with two flow passages that connect the detection space partitioned through the cooperation of the recess portion to the liquid detection chamber.

### TECHNICAL FIELD

The present invention relates to a liquid container and a liquid filling method, and in particular, to a liquid container that supplies a predetermined liquid to a liquid consuming apparatus, such as a liquid ejecting head ejecting minute droplets or the like, and a liquid filling method that fills a liquid in a liquid detection unit of the liquid container.

### BACKGROUND ART

A liquid ejecting head of a liquid ejecting apparatus, such as a printing apparatus, a microdispenser, or a commercial recording apparatus that requires ultrahigh printing quality, receives a liquid from a liquid container, However, if the liquid ejecting head operates in a state where the liquid is not supplied, idle printing occurs, and thus the liquid ejecting head is likely to be damaged. In order to prevent this problem, it is necessary to monitor a liquid residual quantity in the container.

Examples of the recording apparatus include various apparatus that have a liquid detection unit for detecting an ink residual quantity in an ink cartridge as a liquid container.

The specific structure of such a liquid detection unit is suggested in Patent Document 1. In the liquid detection unit, a liquid containing recess portion is formed at one of opposing surfaces of a flexible pouch containing the liquid, a piezoelectric vibrator is disposed at outer surface of the recess portion, and a rigid body is disposed at the other surface, such that the ink residual quantity is detected from a vibration state by a liquid amount (a depth of the liquid) between the rigid body and the piezoelectric vibrator.

However, in the liquid detection unit described in Patent Document 1, the liquid residual quantity can be detected with comparatively high precision, but the residual quantity of ink contained in the flexible pouch is affected by bending or wrinkles of the pouch since the rigid body moves according to the deformation of the flexible pouch, and thus detection precision may be degraded.

Another structure is suggested in Patent Document 2. According to this structure, in an ink cartridge that discharges ink (liquid) by a pressure of a pressurized fluid, normally, air, to be supplied from the outside, a sensor chamber (liquid detection unit) for detecting an ink residual quantity is provided between a liquid delivery portion (liquid derivation portion) to be connected to a recording apparatus and an ink containing portion (liquid containing portion) formed of a flexible film.

Patent Document 1: JP-A-2004-136670

Patent Document 2: JP-A-2004-351871

By the way, in case of an ink cartridge, in general, as a flexible film that forms an ink containing portion, an aluminum-laminated multilayer film having a high gas barrier property is used in order to prevent external air from passing through the film and entering ink.

In case of the above-described ink cartridge, as the flexible film forming the ink containing portion, an aluminum-laminated multilayer film having high gas barrier property is used in order to suppress external air from passing through the film and entering ink.

In addition, ink that is adjusted to a high degree of deaeration in advance is filled in the ink containing portion such that printing quality or maintenance on the recording apparatus is not affected only due to deterioration in the degree of deaeration caused by external air passing through the aluminum-laminated multilayer film and entering ink under warranty. Quality is guaranteed against the deterioration in the degree of deaeration under warranty.

Meanwhile, as a liquid detection unit that detects the ink residual quantity, there is a liquid detection unit having a diaphragm that is deformed by a pressure of flowing ink. In this case, the deformation of the diaphragm is detected by a sensor (detection mechanism), thereby detecting the ink residual quantity.

In the liquid detection unit having this structure, in order to increase the detection precision, the diaphragm needs to be formed of a resin film that is thin and likely to be elastically deformed, such that the diaphragm can be deformed by a slight change in liquid pressure.

By the way, the resin film that is thin and likely to be elastically deformed has a low gas barrier property, compared with the aluminum-laminated multilayer film forming the ink containing portion.

That is, when the detection precision of the liquid detection unit is improved, the gas barrier property of the liquid containing portion is degraded. Accordingly, in the liquid detection unit, external air enters through the diaphragm or the like, and the degree of deaeration is likely to be degraded, compared with the ink containing portion having a high gas barrier property.

As described in Patent Document 2, in case of the ink cartridge having the sensor chamber (liquid detection unit) provided between the liquid delivery port and the ink containing portion, ink having a degraded degree of deaeration in the sensor chamber may flow back to the ink containing portion connected to the sensor chamber, external air entering the sensor chamber may enter the ink containing portion flowing down ink in the sensor chamber, or the degree of deaeration of ink in the ink containing portion may be incorrectly degraded. As a result, there may be a difficulty in printing quality or maintenance on the recording apparatus.

### DISCLOSURE OF THE INVENTION

Accordingly, it is a first object of the invention to provide a liquid container having a function of detecting that a liquid residual quantity becomes a predetermined amount and a good liquid filling method that fills a liquid in a liquid detection unit of the liquid container.

It is a second object of the invention to provide a good liquid container that can secure excellent liquid detection precision, and prevent a degree of deaeration of a liquid in a liquid containing portion from being degraded.

At least one of the above objects of the invention is achieved by the following aspects.

A first aspect of the invention provides a liquid container including a liquid containing portion that is pressurized by a pressure unit and discharges a liquid stored therein through a liquid discharge port, a liquid supply port that supplies the liquid to an external liquid consuming apparatus, and a liquid detection unit that is interposed between the liquid containing portion and the liquid supply port. The liquid detection unit includes a liquid detection chamber that has a liquid inlet port to be connected to the liquid discharge port of the liquid containing portion and a liquid outlet port to be connected to the liquid supply port, a movable member that is movably accommodated in response to a liquid containing amount of the liquid detection chamber, a recess portion that partitions a detection space in cooperation with one surface of the movable member when the liquid containing amount of the liquid detection chamber becomes a predetermined amount or less, and a piezoelectric detection unit that applies vibration to the recess portion and detects a free vibration state according to the applied vibration. In this case, the movable member is provided with two flow passages that connect the detection space partitioned with the cooperation of the recess portion to the liquid detection chamber.

According to this structure, if the liquid containing amount in the liquid detection chamber becomes the predetermined amount or less, the movable member partitions the detection space in cooperation with the recess portion as a vibration reaction region. Accordingly, a change in free vibration state to be detected by the piezoelectric detection unit markedly appears, and the time or state that the liquid containing amount of the liquid detection chamber reaches a predetermined level can be accurately and reliably detected.

When the liquid is absorbed from the liquid supply port to be connected to a liquid consuming apparatus in order to fill the liquid in the liquid detection chamber, an absorption force exerts action on two flow passages provided in the movable member, and then the liquid is supplied to the liquid supply port while going back the flow passage on which the absorption force exerts action.

That is, the liquid is reliably filled in the recess portion as the vibration reaction region, and bubbles do not remain in the recess portion. Therefore, detection precision can be prevented from being degraded due to remaining bubbles

In the liquid container having the above structure, one of the two flow passages may extend to the vicinity of the liquid outlet port.

According to this structure, the absorption force that absorbs the liquid from the liquid supply port in order to fill the liquid to the liquid detection chamber easily exerts action on one of the two flow passages through the liquid outlet port. Further, the absorption force reliably exerts action on the recess portion connected to the one flow passage.

Therefore, the liquid in the liquid detection chamber is easily absorbed through the recess portion connected to the two flow passages, and the bubbles remaining in the recess portion are easily eliminated.

In the liquid container having the above structure, one of the two flow passages may extend to the vicinity of the liquid inlet port.

According to this structure, the absorption force that absorbs the liquid from the liquid supply port in order to fill the liquid in the liquid detection chamber reliably exerts action on the liquid outlet inlet port through the other one of the two flow passages.

Therefore, the liquid supplied from the liquid containing portion to the liquid in let port easily flows in the recess portion through the other flow passage, and the bubbles remaining in the recess portion is easily eliminated.

In the liquid container having the above structure, the two flow passages may extend to the vicinity of the liquid outlet port and the vicinity of the liquid outlet port, respectively.

According to this structure, the absorption force that absorbs the liquid from the liquid supply port in order to fill the liquid in the liquid detection chamber reliably exerts action on one of the two flow passages through the liquid outlet port and on the liquid inlet port through the other one of the two flow passages.

Therefore, the liquid in the liquid containing portion is easily absorbed through the recess portion connected to the two flow passages, and the bubbles remaining in the recess portion are easily eliminated.

In the liquid container having the above structure, the liquid detection chamber may be configured by sealing an opening formed at its upper surface with a film that is deformable according to the liquid containing amount, and the piezoelectric detection unit may be disposed at the bottom of the liquid detection chamber.

According to this structure, the liquid detection chamber can be easily deformed corresponding to a liquid containing amount (a change in pressure) of the liquid detection chamber and can be easily formed as a closed space. In addition, ink leakage can be prevented with a simple structure.

In the liquid container having the above structure, the movable member may move by the deformation of the film corresponding to a change in liquid containing amount of the liquid detection chamber. In addition, in the liquid container having the above structure, the movable member may be fixed to the film.

According to this structure, with the easy deformation of the film, the movable member can smoothly follow the liquid level or pressure.

In the liquid container having the above structure, the movable member may have, in a region facing a vibration surface of the piezoelectric detection unit, a surface substantially parallel to the vibration surface.

According to this structure, the detection space whose volume changes in response to the liquid level can be easily formed.

In the liquid container having the above structure, the movable member may be urged by an urging unit in a direction in which the piezoelectric detection unit is disposed. In addition, in the liquid container having the above structure, the urging unit may be formed of an elastic member.

According to this structure, by adjusting an urging force by the urging unit, the time at which the one surface of the movable member partitions the detection space in cooperation with the recess portion can be changed, and simultaneously an internal pressure (liquid residual quantity) in the liquid detection chamber to be detected can be easily set.

In the liquid container having the above structure, a time at which the movable member partitions the detection space in cooperation with the recess portion may be set to a state where the liquid of the liquid containing portion is exhausted.

In addition, in the liquid container having the above structure, a time at which the movable member partitions the detection space in cooperation with the recess portion may be set to a state where the liquid of the liquid containing portion is nearly exhausted.

According to this structure, for example, when the liquid container is used as an ink cartridge, the piezoelectric detection unit of the liquid detection unit can be effectively used as an ink end detection mechanism for detecting that the ink residual quantity in the liquid containing portion becomes zero, or an ink end detection mechanism for detection a state where the ink residual quantity becomes zero soon.

In the liquid container having the above structure, the recess portion may have two openings and, when the recess portion partitions the detection space in cooperation with the movable member, the two openings maybe connected to the two flow passages of the movable member.

According to this structure, when the liquid is absorbed from the liquid supply port to be connected to the liquid consuming apparatus in order to fill the liquid in the liquid detection chamber, the absorption force reliably exerts action on the recess portion having the two openings connected to the two flow passages provided in the movable member, respectively, and the liquid is supplied to the liquid supply port while going back the flow passage on which the absorption force exerts action. That is, since the recess portion has a flow passage shape having the two openings, a bubble discharge property can be improved.

In the liquid container having the above structure, in at least a posture when the liquid is filled in the liquid detection chamber, even though the two openings of the recess portion do not have a difference in height, two openings on sides not connected to the recess portion at the two flow passages of the movable member may be disposed to have a difference in height.

According to this structure, even in a layout where the two openings of the recess portion are in parallel with each other with no difference in height when the liquid is filled in the liquid detection chamber due to electrode arrangement of the piezoelectric detection unit or the like, the two openings on sides not connected to the recess portion at the two flow passages of the movable member are disposed to have a difference in height. Therefore, the opening of the movable member on a lower side when the liquid is filled in the recess portion is set as the liquid inlet port, and thus a flow direction can be made clear. As a result, the bubble discharge property of the recess portion when the liquid is filled in the liquid detection chamber can be secured.

A second aspect of the invention provides a liquid filling method that fills a liquid in a liquid detection unit of the liquid container according to the first aspect. Here, the liquid is filled in the liquid detection unit in a state where a difference in height between two openings on sides not connected to the recess portion at the two openings of the movable member is secured.

According to the liquid filling method having the above structure, when the liquid is absorbed from the liquid supply port to be connected to the liquid consuming apparatus and is filled in the liquid detection unit, there is a difference in height between the two openings of the movable member. Therefore, the opening of the movable member on a lower side when the liquid is filled in the recess portion is set as the liquid inlet port, and thus a flow direction can be made clear. As a result, a bubble discharge property of the liquid detection unit can be improved.

In the liquid container according to the first aspect of the invention, if the liquid containing amount of the liquid detection chamber becomes the predetermined amount or less, the movable member partitions the detection space in cooperation with the recess portion. Therefore, the change in free vibration state markedly appears, and the time or state that the liquid containing amount of the liquid detection chamber reaches the predetermined level can be accurately and reliably detected.

When the liquid is absorbed from the liquid supply port to be connected to the liquid consuming apparatus in order to fill the liquid in the liquid detection chamber, the absorption force exerts action on the two flow passages of the movable member, and the liquid is supplied to the liquid supply port while going back the flow passage on which the absorption force exerts action.

That is, the liquid is reliably filled in the recess portion as the vibration reaction region, and the bubbles do not remain in the recess portion. Therefore, the detection precision can be prevented from being degraded due to remaining bubbles, and the liquid containing amount can be detected with high precision.

In the liquid filling method according to the second aspect of the invention, when the liquid is absorbed from the liquid supply port to be connected to the liquid consuming apparatus and is filled in the liquid detection unit, there is a difference in height between the two openings of the movable member. Then, the opening of the movable member on the lower side when the liquid is filled in the recess portion is set as the liquid inlet port, and the flow direction is made clear. As a result of the bubble discharge property of the liquid detection unit is improved.

Therefore, it is possible to provide a liquid container having a function of detecting that the liquid residual quantity becomes zero, and a good liquid filling method that fills a liquid in the liquid detection unit of the liquid container.

A third aspect of the invention provides a liquid container includes a liquid containing portion that is pressurized by a pressure unit and discharges a liquid stored therein from a liquid discharge port, a liquid supply port that supplies the liquid to an external liquid consuming apparatus, and a liquid detection unit that is interposed between the liquid containing portion and the liquid supply port. Here, the liquid detection unit includes a liquid detection chamber that has a liquid inlet port to be connected to the liquid discharge port of the liquid containing portion and a liquid outlet port to be connected to the liquid supply port, a movable member that moves in response to a liquid containing amount of the liquid detection chamber, a recess that is provided in the movable member to partition a detection space in cooperation with a recess portion provided in the liquid detection chamber when the liquid containing amount of the liquid detection chamber becomes a predetermined amount or less, and a piezoelectric detection unit that applies vibration to the recess portion and detects a free vibration state according to the applied vibration.

According to this structure, if the liquid containing amount of the liquid detection chamber becomes the predetermined amount or less, the recess of the movable member partitions the detection space as the vibration reaction region in cooperation with the recess portion. Accordingly, a frequency having acoustic impedance corresponding to the total volume of the recess portion and the recess appears. This frequency becomes a frequency lower than a frequency by acoustic impedance when the movable member is separated from the recess portion, and a difference markedly appears.

Therefore, the change in free vibration state to be detected by the piezoelectric detection unit, and the time or state that the liquid containing amount of the liquid detection chamber reaches the predetermined level can be accurately and reliably detected.

The recess portion provided in the liquid detection chamber partitions the detection space in cooperation with the recess provided in the movable member so as to increase the volume of the detection space. Accordingly, there is no case where residual vibration becomes small due to an insufficient volume of the vibration reaction region and the detection is impossible, or, even though the detection is possible, a difference cannot be distinguished due to a slight difference in frequency when the recess portion is opened in the liquid detection chamber and when the recess portion is blocked.

That is, the volume of the detection space as the vibration reaction region changes due to the movement of the movable member, and the acoustic impedance varies. Accordingly, by detecting the difference in frequency of the residual vibration, it is possible to detect with high precision that the liquid containing amount of the liquid detection chamber reaches the predetermined level.

In the liquid container having the above structure, the recess may be formed of a member having at least one elastic surface.

According to this structure, in the detection space that is partitioned by the recess portion of the liquid detection chamber in cooperation with the recess of the movable member, the attenuation of the residual vibration is suppressed by a volume change characteristic (compliance) due to elastic deformation of the elastic member forming at least one surface of the recess. As a result, the amplitude of the residual vibration can be easily detected, and the detection precision can be improved.

In the liquid container having the above structure, the elastic member may be a film.

According to this structure, for example, when the recess is provided in a plate-shaped movable member, the recess having a volume change characteristic (compliance) due to the elastic deformation can be simply formed only by blocking an opening formed to pass through the movable member with the film as the elastic member.

In the liquid container having the above structure, the recess may be connected to the liquid detection chamber.

According to this structure, even though the compliance of the recess is not secured by forming one surface of the recess with the elastic member, by connecting the recess to the liquid detection chamber as a large liquid space, the attenuation of the residual vibration of the detection space partitioned by the recess portion in cooperation with the recess is suppressed. Accordingly, the amplitude of the residual vibration upon detection can be secured, and the detection precision can be improved.

In the liquid container having the above structure, the recess may have two flow passages that connect the recess portion to the liquid detection chamber.

According to this structure, when the liquid is absorbed from the liquid supply port to be connected to the liquid consuming apparatus in order to fill the liquid in the liquid detection chamber, the absorption force exerts action on the two flow passages provided in the movable member, and the liquid is supplied to the liquid supply port while going back the flow passage on which the absorption force exerts action.

That is, the liquid is reliably filled even in the recess portion of the liquid detection chamber as the vibration reaction region, and the bubbles do not remain in the recess portion. Therefore, the detection precision can be prevented from being degraded due to remaining bubbles.

In the liquid container having the above structures the liquid detection chamber may be configured by sealing an opening formed at its upper surface with a film that is deformable according to the liquid containing amount, and the piezoelectric detection unit may be disposed at the bottom of the liquid detection chamber.

According to this structure, the liquid detection chamber can be easily deformed corresponding to a change in liquid containing amount (a change in pressure) of the liquid detection chamber and can be easily formed as a closed space. In addition, ink leakage can be prevented with a simple structure.

In the liquid container having the above structure, the movable member may move by the deformation of the film corresponding to a change in liquid containing amount of the liquid detection chamber. In addition, in the liquid container having the above structure, the movable member may be fixed to the film

According to this structure, with the easy deformation of the film, the movable member can smoothly follow the liquid level or pressure.

In the liquid container having the above structure, the movable member may have a surface that is, in a region facing a vibration surface of the piezoelectric detection unit, substantially in parallel with the vibration surface.

According to this structure, the detection space whose volume changes in response to the liquid amount can be easily formed.

In the liquid container having the above structure, the movable member may be urged in a direction in which the piezoelectric detection unit is disposed. In addition, in the liquid container having the above structure, the urging unit may be formed of an elastic member.

According to this structure, by adjusting an urging force by the urging unit, the time at which the recess of the movable member partitions the detection space in cooperation with the recess portion of the liquid detection chamber can be changed, and simultaneously an internal pressure (liquid residual quantity) in the liquid detection chamber to be detected can be easily set.

In the liquid container having the above structure, a time at which the recess partitions the detection space in cooperation with the recess portion may be set to a state where the liquid of the liquid containing portion is exhausted. In addition, in the liquid container having the above structure, a time at which the recess partitions the detection space in cooperation with the recess portion may be set to a state where the liquid of the liquid containing portion is nearly exhausted.

According to this structure, for example, when the liquid container is used as an ink cartridge, the piezoelectric detection unit of the liquid detection unit can be effectively used as an ink end detection mechanism for detecting that the ink residual quantity in the liquid containing portion becomes zero, or an ink end detection mechanism for detection a state where the ink residual quantity becomes zero soon.

In the liquid container according to the third aspect of the invention, if the liquid containing amount of the liquid detection chamber becomes the predetermined amount or less, the recess of the movable member partitions the detection space in cooperation with the recess portion of the liquid detection chamber. Therefore, the change in free vibration state to be detected by the piezoelectric detection unit markedly appears, and the time or state that the liquid containing amount of the liquid detection chamber reaches the predetermined level can be accurately and reliably detected.

The recess portion of the liquid detection chamber partitions the detection space in cooperation with the recess of the movable member so as to increase the volume of the detection space. Accordingly, there is no case where the residual vibration becomes small due to an insufficient volume of the vibration reaction region and the detection is impossible, or, even though the detection is possible, a difference cannot be distinguished due to a slight difference in frequency when the recess portion is opened in the liquid detection chamber and when the recess portion is blocked.

Accordingly, the volume of the detection space as the vibration reaction region changes due to the movement of the movable member, and the acoustic impedance varies. Therefore, by detecting the difference in frequency of the residual vibration, it is possible to detect with high precision that the liquid containing amount of the liquid detection chamber reaches the predetermined level.

A fourth aspect of the invention provides a liquid container including a liquid containing portion in which a liquid can be filled in advance at high degree of deaeration, a liquid detection unit that has a gas barrier property lower than the liquid containing portion, a liquid derivation portion that derives the liquid of the liquid containing portion to the outside through the liquid detection unit, and an on/off valve that is provided in a flow passage between the liquid detection unit and the liquid containing portion so as to open/close the flow passage.

The high degree of deaeration means a state that has a dissolved gas amount smaller than a dissolved gas amount (a dissolved gas amount in a saturation state) under an atmospheric pressure at a normal temperature (25° C.) by 20%.

According to this structure, when the liquid of the liquid containing portion is not derived to the outside, the on/off valve provided in the flow passage between the liquid detection unit and the liquid containing portion is closed so as to block between the liquid containing portion and the liquid detection unit. Accordingly, the liquid or gas can be prevented from flowing from the liquid detection unit in the liquid containing portion.

Then, even though the gas barrier property of the liquid detection unit is lower than the liquid containing portion, there is no case where the degree of deaeration of the liquid in the liquid containing portion is degraded due to a back flow of gas entering the liquid detection unit or the like.

Therefore, the liquid detection unit can improve the liquid detection precision without concern for the degradation of the gas barrier property, can secure excellent liquid detection precision, and can prevent the degradation of the degree of deaeration of the liquid in the liquid containing portion.

In the liquid container having the above structure, the on/off valve maybe a check valve that opens a flow of a derivation direction of the liquid to the outside, and closes a reverse flow.

According to this structure, the on/off valve as the check valve may have a structure in which an opening of a flow passage between the liquid detection unit and the liquid containing portion is sealed with an urging force by the flow of the liquid from the liquid detection unit. For example, the on/off valve can be implemented by a simple structure using a thin plate-shaped valve body. Therefore, the degradation of the degree of deaeration of the liquid in the liquid containing portion can be prevented at low cost.

In the liquid container having the above structure, the liquid detection unit and the liquid containing portion may be separable from each other, and the on/off valve may be provided in a flow passage close to the liquid detection unit to be connected to the liquid containing portion.

According to this structure, the liquid containing portion is an independent part that has no relation with the provision of the on/off valve. Accordingly, the use of a liquid containing portion for a known liquid container that is not provided with the on/off valve between the liquid detection unit and the liquid containing portion is possible, and the development of the liquid container becomes easy.

In the liquid container having the above structure, the liquid detection unit and the liquid containing portion may be separable from each other, and the on/off valve may be provided in a flow passage close to the liquid containing portion to be connected to the liquid detection unit.

According to this structure, the liquid containing portion is an independent part that has no relation with the provision of the on/off valve. Accordingly, the use of a liquid containing portion for a known liquid container that is not provided with the on/off valve between the liquid detection unit and the liquid containing portion is possible, and the development of the liquid container becomes easy.

In the liquid container having the above structure, the liquid of the liquid containing portion may be pressurized by a pressure of pressurized air to be supplied from a pressurized gas injection portion and then may be derived from a liquid supply portion to the outside. In addition, the liquid detection unit may be disposed in a region that is blocked from a pressure of the pressurized gas, and may include a diaphragm that is deformed by a change in pressure due to an inflow of the liquid from the liquid containing portion and a detection mechanism that detects the deformation of the diaphragm.

According to this structure, when the pressure by pressurized gas against the liquid containing portion is constant, if the liquid residual quantity of the liquid containing portion becomes small, the derivation amount of the liquid to the liquid detection unit decreases, the pressure in the liquid detection unit decreases, and the diaphragm is deformed by a change in pressure at that time. Accordingly, the liquid residual quantity in the liquid container can be calculated from the deformation of the diaphragm. In this case, by using a diaphragm that is likely to be deformed by the change in pressure of the liquid detection unit, residual quantity detection precision can be improved, while the gas barrier property of the liquid detection unit is degraded.

However, in the liquid container according to the fourth aspect of the invention, when the liquid in the liquid containing portion is not derived to the outside, the on/off valve blocks between the liquid containing portion and the liquid detection unit. Accordingly, the liquid or gas can be suppressed from entering from the liquid detection unit having a low gas barrier property to the liquid containing portion having a high gas barrier property. For this reason, the degradation of the gas barrier property of the liquid detection unit has no affect on the degradation of the degree of deaeration of the liquid in the liquid containing portion. Accordingly, by using the diaphragm that is likely to be deformed by the change in pressure of the liquid detection unit, the residual quantity detection precision can be improved.

In the liquid container having the above structure, the liquid detection unit may be configured by sealing an opening of a recess portion provided in a member forming the liquid detection unit with a flexible film.

According to this structure, the flexible film functions as a diaphragm that is deformed by the change in pressure of the liquid detection unit, and thus the structure of the liquid detection unit can be simplified.

In the liquid container having the above structure, the diaphragm may be urged by an urging member, which is elastically deformable by a pressure of the liquid flowing from the liquid containing portion, in a direction in which the volume of the liquid detection unit is reduced.

According to this structure, the deformation of the diaphragm with respect to the change in pressure of the liquid detection unit becomes accurate, and reliability of a residual quantity detection operation can be improved.

In the liquid container having the above structure, the liquid containing portion maybe a flexible pouch that is formed by attaching flexible films, and the films may be multilayer films including an aluminum layer.

According to this structure, the liquid containing portion can have flexibility such that the liquid therein is easily pressed out to the last, and a high gas barrier property to such an extent that the degree of deaeration can be prevented from being degraded. Therefore, it is possible to implement a good liquid containing portion in which a waste due to an unused liquid is small, and the degree of deaeration of the stored liquid is suppressed from being degraded.

In the liquid container having the above structure, the liquid may be ink.

According to this structure, the degree of deaeration of the liquid stored in the liquid containing portion can be suppressed from being degraded, and the ink residual quantity in the liquid containing portion can be detected with high precision. Therefore, it is suitably used for an ink cartridge that is mounted on the ink jet recording apparatus.

In the liquid container according to the fourth aspect of the invention, when the liquid in the liquid containing portion is not derived to the outside, the on/off valve blocks between the liquid containing portion and the liquid detection unit, such that the liquid or gas can be prevented from entering from the liquid detection unit to the liquid containing portion.

Therefore, the liquid detection unit can improve the liquid detection precision without concern for the degradation of the gas barrier property, secure excellent liquid detection precision, and prevent the degree of deaeration of the liquid in the liquid containing portion from being degraded.

The present disclosure relates to the subject matter contained in Japanese patent application Nos. 2005-323977 filed on Nov. 8, 2005, 2005-347091 filed on Nov. 30, 2005, 2005-353111 filed on Dec. 7, 2005 and 2006-215220 filed on Aug. 8, 2006, which are expressly incorporated herein by reference in its entirety.

### BRIEF DESCRIPTION OF THE DRAWINGS

FIG. 1 is a longitudinal cross-sectional view of a liquid container according to a first embodiment of the invention, and shows a state where a liquid is absorbed from a liquid containing portion in a non-pressurized state through a liquid supply port.

FIG. 2 is a longitudinal cross-sectional view showing a state where the liquid containing portion of the liquid container shown in FIG. 2 is pressurized.

FIG. 3 is a longitudinal cross-sectional view of a liquid container according to a second embodiment of the invention.

FIG. 4 is a longitudinal cross-sectional view of a liquid container according to a third embodiment of the invention.

FIG. 5 is a longitudinal cross-sectional view of a liquid container as a comparative example, in which a first flow passage and a second flow passage are removed from a pressure receiving plate of a liquid container according to the invention.

FIG. 6 is an enlarged cross-sectional view of the liquid container shown in FIG. 5, and shows a state where a liquid is absorbed from a liquid containing portion in a non-pressurized state through a liquid supply port.

FIG. 7 is a longitudinal cross-sectional view illustrating a liquid filling method when a liquid is filled in a liquid detection unit of the liquid container shown in FIG. 4.

FIG. 8 is a horizontal cross-sectional view of a liquid container according to a fourth embodiment of the invention.

FIG. 9 is a longitudinal cross-sectional view of a liquid container according to a fifth embodiment of the invention.

FIGS. 10A to 10C are a top view and cross-sectional views illustrating a liquid detection unit of the liquid container shown in FIG. 9.

FIG. 11 is a longitudinal cross-sectional view of a liquid container according to a sixth embodiment of the invention, and shows a state where a liquid containing amount of a liquid detection unit becomes a predetermined amount or less.

FIG. 12 is a longitudinal cross-sectional view showing a state where a liquid containing portion of the liquid container shown in FIG. 11 is pressurized.

FIG. 13 is a longitudinal cross-sectional view of a liquid container according to a seventh embodiment of the invention.

FIG. 14 is a longitudinal cross-sectional view of a liquid container according to an eighth embodiment of the invention.

FIG. 15 is a longitudinal cross-sectional view of a liquid container according to a ninth embodiment of the invention.

FIG. 16 is a longitudinal cross-sectional view of a liquid container according to a tenth embodiment of the invention.

FIG. 17 is a longitudinal cross-sectional view of a liquid container according to an eleventh embodiment of the invention.

FIG. 18 is an enlarged cross-sectional view showing the operation when a liquid of a liquid detection unit shown in FIG. 17 is derived.

FIG. 19 is a longitudinal cross-sectional view of a liquid container according to a twelfth embodiment of the invention.

FIG. 20 is a longitudinal cross-sectional view of a liquid container according to a thirteenth embodiment of the invention.

### BEST MODES OF CARRYING OUT THE INVENTION

A liquid container according to an embodiment of the invention will now be described in detail with reference to the accompanying drawings.

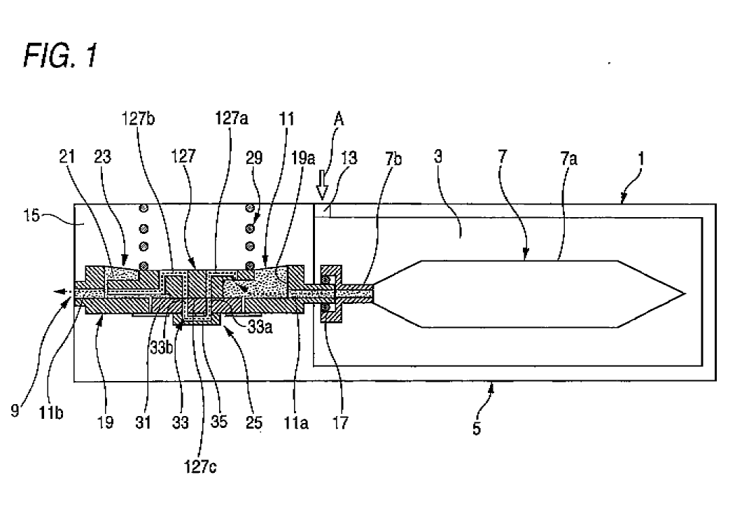

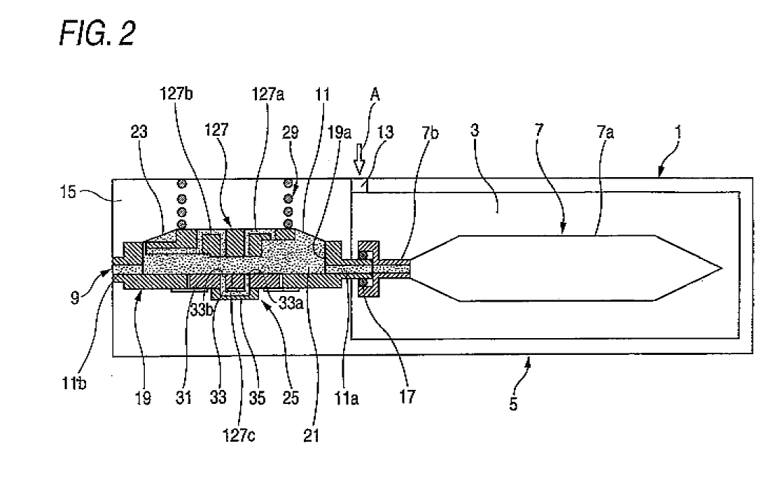

FIG. 1 is a longitudinal cross-sectional view of a liquid container according to a first embodiment of the invention. FIG. 1 shows a state where a liquid is absorbed from a liquid containing portion in a non-pressurized state to a liquid supply port. FIG. 2 is a longitudinal cross-sectional view showing a state where the liquid containing portion of the liquid container shown in FIG. 1 is pressurized.

The liquid container 1 of the first embodiment is an ink cartridge that is detachably mounted on a cartridge mounting portion of an ink jet recording apparatus (liquid consuming apparatus) (not shown) and supplies ink (liquid) to a printing head provided in the recording apparatus.

As shown in FIG. 1, the liquid container 1 includes a container main body 5, in which a pressure chamber 3 is partitioned to be pressurized by a pressure unit (not shown), an ink pack (liquid containing portion) 7 that stores ink, is accommodated in the pressure chamber 3, and discharges ink stored therein from a discharge port (liquid discharge port) 7b by a pressure of the pressure chamber 3, and an ink detection unit (liquid detection unit) 11 that is interposed between the ink pack 7 and the ink supply port 9 so as to detect an ink residual quantity.

The container main body 5 is a flat rectangular parallel piped casing formed of resin. The container main body 5 includes the pressure chamber 3 that is in a closed state, a pressure port 13 that serves as a pressurized gas injection portion for allowing the pressure unit (not shown) to send pressurized air to the pressure chamber 3, as indicated by an arrow A, and a detection unit accommodating chamber 15 that accommodates the ink detection unit 11. The detection unit accommodating chamber 15 is a region that is blocked from a pressure of the pressurized gas to be supplied to the pressure chamber 3.

The container main body 5 is not necessarily a resin member integrally formed insofar as the pressure chamber 3 can be in the closed state.

The ink pack 7 has a flexible pouch body 7a that is formed by attaching edges of aluminum-laminated multilayer films, on which an aluminum layer is laminated on a flexible resin film, to each other. A cylindrical discharge port 7b, to which an ink inlet port (liquid inlet port) 11a of the ink detection unit 11 is connected, is bonded to one end of the flexible pouch body 7a. The ink pack 7 is formed of the aluminum-laminated multilayer film, thereby ensuring a high gas barrier property.

The ink pack 7 and the ink detection unit 11 are connected to each other by engaging the ink inlet port 11a with the discharge port 7b. That is, the ink pack 7 and the ink detection unit 11 can be detached from each other by releasing the engagement of the discharge port 7b and the ink inlet port 11a.

A packing 17 that connects the discharge port 7b and the ink inlet port 11a to each other airtight is provided in the discharge port 7b. In the ink pack 7, ink that is adjusted in advance at a high degree of deaeration before the ink detection unit 11 is connected is filled.

The ink detection unit 11 includes a detection unit case 19 that has a recess space 19a connecting the ink inlet port 11a connected to the discharge port 7b of the ink pack 7 and an ink outlet port (liquid outlet port) 11b connected to the ink supply port 9 along a longitudinal direction of the flat rectangular parallelepiped container main body 5 (a left and right direction in FIG. 1), a flexible film 23 that seals an opening the recess space 19a so as to partition a sensor chamber (liquid detection chamber) 21, a pressure detection unit 25 that is provided at the bottom of the recess space 19a, a pressure receiving plate (movable member) 127 that is fixed to the flexible film 23 to face the pressure detection unit 25, and a compression coil spring (urging member) 29 that is compressed between the pressure receiving plate 127 and an upper wall of the detection unit accommodating chamber 15 and elastically urges the pressure receiving plate 127 and the flexible film 23 in a direction in which the volume of the sensor chamber 21 is reduced.

In the detection unit case 19, the ink inlet port 11a is integrally formed at one end of a peripheral wall partitioning the recess space 19a, and the ink outlet port 11b that is connected to the ink supply port 9 is formed to pass through the peripheral wall facing the ink inlet port 11a. Though not shown, a valve mechanism is provided in the ink supply port 9. The valve mechanism opens a flow passage when the ink cartridge is mounted on the cartridge mounting portion of the ink jet recording apparatus and an ink supply needle provided in the cartridge mounting portion is inserted into the ink supply port 9.

The pressure detection unit 25 of the ink detection unit 11 includes a bottom plate 31 that comes into close contact with the pressure receiving plate 127 by an urging force of the compression coil spring 29 when ink is not derived from the ink pack 7 to the ink supply port 9, an ink guide path 33 that is a recess portion formed in the bottom plate 31, and a piezoelectric sensor (piezoelectric detection unit) 35 that applies vibration to the ink guide path 33 and detects a free vibration state according to the vibration.

The piezoelectric sensor 35 can detect different tree vibration states according to whether or not the ink guide path 33 is covered with the pressure receiving plate 127.

For example, a control unit that is provided in the ink jet recording apparatus can detect a pressure in the sensor chamber 21 by detecting deformation of the flexible film 23 that is supporting the pressure receiving plate 127 according to the free vibration state detected by the piezoelectric sensor 35.

An urging direction of the compression coil spring 29 is a direction in which the volume of the sensor chamber 21 is reduced, as described above, and a direction in which the piezoelectric sensor 35 is disposed.

The ink guide path 33 that is a recess portion formed in the bottom plate 31 has a flow passage that has two openings 33a and 33b connected to each other in a longitudinal direction of the container main body 5. As shown in FIG. 1, in a state where the pressure receiving plate 127 comes into close contact with the bottom plate 31, the ink guide path 33 partitions the detection space in cooperation with one surface 127c of the pressure receiving plate 127. A first flow passage 127a and a second flow passage 127b (described below) of the pressure receiving plate 127 are connected to the openings 33a and 33b, respectively. Meanwhile, as shown in FIG. 2, if the pressure receiving plate 127 is separated from the bottom plate 31, the ink guide path 33 is opened to the sensor chamber 21 through the two openings 33a and 33b. The one surface 127c of the pressure receiving plate 127 is, in a region facing a vibration surface of the piezoelectric sensor 35, substantially in parallel with the vibration surface.

As shown in FIG. 2, it ink is supplied from the ink pack 7 to the sensor chamber 21 due to a pressure of the ink pack 7 by pressurized air to be supplied to the pressure chamber 3, in the ink detection unit 11, the flexible film 23 is swelled and deformed upward according to a change in ink containing amount (liquid level) in the sensor chamber 21 accordingly. With the deformation of the flexible film 23, the pressure receiving plate 127 that forms a portion of a partition of the sensor chamber 21 moves upward, and the pressure receiving plate 127 is separated from the bottom plate 31. It the pressure receiving plate 127 is separated from the bottom plate 31, the ink guide path 33 is opened to the sensor chamber 21, and then ink is supplied from the ink supply port 9 to the recording head through the sensor chamber 21.

Even though a predetermined pressure is applied to the pressure chamber 3, if ink contained in the ink pack 7 decreases, the amount of ink to be supplied from the ink pack 7 to the sensor chamber 21 decreases. Accordingly, the pressure in the sensor chamber 21 decreases, and thus the pressure receiving plate 127 approaches the bottom plate 31 having the ink guide path 33.

In this embodiment, the pressure receiving plate 127 comes into contact with the bottom plate 31 by the decrease in pressure of the sensor chamber 21, and a time at which the pressure receiving plate 127 partitions the detection space in cooperation with the ink guide path 33 is set to a state where ink of the ink pack 7 is exhausted.

The flexible film 23 functions as a diaphragm that applies displacement to the pressure receiving plate 127 according to a pressure of ink to be supplied to the sensor chamber 21. In order to detect a minute change in pressure of ink and to improve detection precision, the flexible film 23 preferably has sufficient flexibility.

As shown in FIG. 1, the pressure receiving plate 127 of this embodiment is provided with the first flow passage 127a and the second flow passage 127b that are two flow passages connecting the detection space formed through the cooperation of the ink guide path 33 to the sensor chamber 21.

In addition, the second flow passages 127b as one of the two flow passages extends to the vicinity of the ink outlet port 11b.

In the above-described liquid container 1 according to this embodiment, if the liquid containing amount in the sensor chamber becomes a predetermined amount or lesser the pressure receiving plate 127 cones into contact with the bottom plate 31, and partitions the detection region in cooperation with the ink guide path 33 as a vibration reaction region. Accordingly, a change in free vibration state to be detected by the piezoelectric sensor 35 markedly appears, and a time or a state that the liquid containing amount in the sensor chamber reaches a predetermined level can be accurately and reliably detected.

Further, when ink is absorbed from the ink supply port 9 to be connected to the ink jet recording apparatus in order to fill ink in the sensor chamber 21, an absorption force exerts action on the discharge port 7b of the ink pack 7 connected to the sensor chamber 21 through the second flow passage 127b formed in the pressure receiving plate 127, the ink guide path 33, and the first flow passage 127a. Then, ink is supplied to the ink supply port 9 while going back the flow passage on which the absorption force exerts action. Here, since the ink guide path 33 of this embodiment is a flow passage having the two openings 33a and 33b, the absorption force from the ink supply port 9 can reliably exert action on the ink guide path 33 having the two openings 33a and 33b that connect the first flow passage 127a and the second flow passage 127b, respectively, and thus a bubble discharge property can be improved.

That is, ink is reliably filled in the ink guide path 33 as the vibration reaction region, and bubbles do not remain in the ink guide path 33. Accordingly, the detection precision can be prevented from being degraded due to remaining bubbles, and the ink containing amount can be detected with high precision.

Therefore, the liquid container 1 of this embodiment can have a function of detecting that the ink residual quantity becomes a predetermined amount.

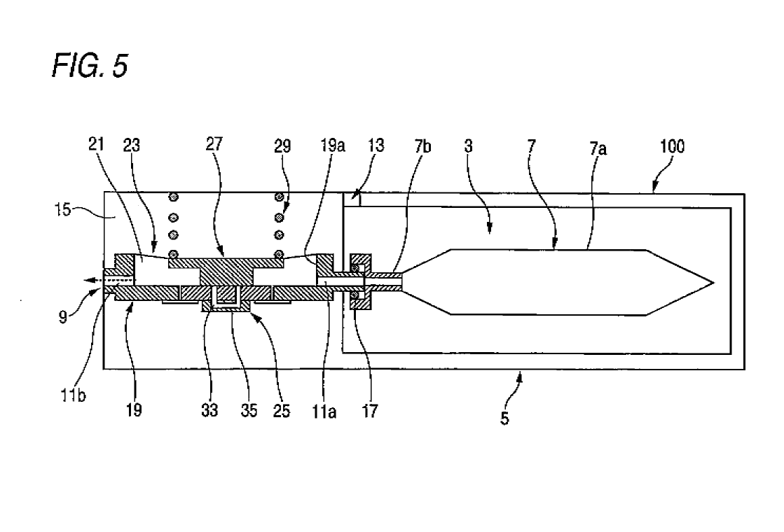

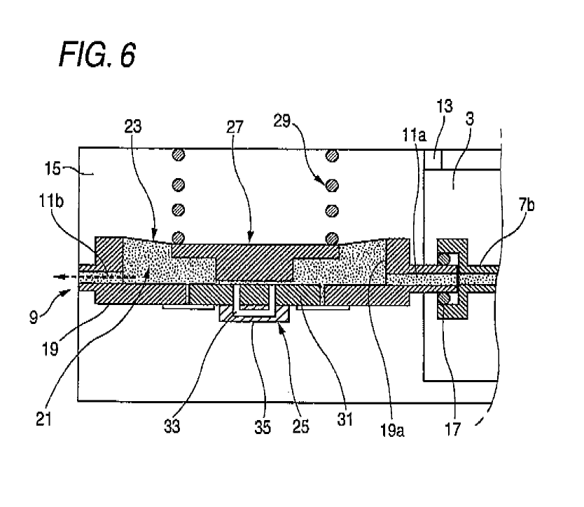

For reference, a liquid container 100 that includes a pressure receiving plate 27 not having provided therein the first flow passage 127a and the second flow passage 127b is shown in FIGS. 5 and 6. Moreover, the liquid container 100 has the same structure as the above liquid container 1, except that the pressure receiving plate 27 are not provided with the first flow passage 127a and the second flow passage 127b.

In case of the liquid container 100, when ink is absorbed from the ink supply port 9 connected to the ink jet recording apparatus in order to fill ink in the sensor chamber 21, as shown in FIG. 5, the pressure receiving plate 27 comes into close contact with the bottom plate 31 by the urging force of the compression coil spring 29, and the ink guide path 33 is closed by the pressure receiving plate 27.

Then, even though the absorption from the ink supply port 9 is performed, in case of the liquid container 100, the absorption force does not exert action on the ink guide path 33, and thus, as shown in FIG. 6, ink is rarely filled in the ink guide path 33. As a result, bubbles remaining in the ink guide path 33 may flow toward the recording head and cause a trouble. Further, the free vibration state to be detected by the piezoelectric sensor 35 may be incorrect due to the remaining bubbles, and the precision of the residual quantity may be degraded.

In the liquid container 1 of this embodiment, the second flow passage 127b formed in the pressure receiving plate 127 extends to the vicinity of the ink outlet port 11b. Accordingly, when ink is absorbed from the ink supply port 9 in order to fill ink in the sensor chamber 21, the absorption force easily exerts action on the second flow passage 127b through the ink outlet port 11b, and reliably exerts action on the ink guide path 33 that is connected to the second flow passage 127b.

Therefore, ink in the sensor chamber 21 is easily absorbed through the ink guide path 33 connected to the first flow passage 127a and the second flow passage 127b, and the bubbles remaining in the ink guide path 33 are easily eliminated.

In the liquid container 1 of this embodiment, the sensor chamber 21 is configured by sealing the opening formed at the upper surface with the flexible film 23 that is deformable according to the ink containing capacity. The piezoelectric sensor 35 is disposed at the bottom of the sensor chamber 21.

For this reason, the sensor chamber 21 can be easily deformed corresponding to the change in liquid containing amount (a change in pressure), and can be easily configured as a closed space. In addition, ink leakage can be prevented with a simple structure.

In the liquid container 1 of this embodiment, the pressure receiving plate 127 is fixed to the flexible film 23, and moves by the deformation of the flexible film 23 corresponding to the change in liquid containing amount of the sensor chamber 21.

With the easy deformation of the flexible film 23, the pressure receiving plate 127 can smoothly follow the liquid level or pressure.

In the liquid container 1 of this embodiment, the one surface 127c of the pressure receiving plate 127 is, in the region facing the vibration surface of the piezoelectric sensor 35, substantially in parallel with the vibration surface. Accordingly, the detection space whose volume changes according to the liquid level can be easily formed.

In the liquid container 1 of this embodiment, the pressure receiving plate 127 is urged by the compression coil spring 29 as the urging unit formed of an elastic member in the direction in which the piezoelectric sensor 35 is disposed.

By adjusting the urging force of the compression coil spring 29, the time at which the one surface 127c of the pressure receiving plate 127 partitions the detection space in cooperation with the ink guide path 33 can be arbitrarily changed, and simultaneously an internal pressure (liquid residual quantity) of the sensor chamber 21 to be detected can be easily set.

In the liquid container 1 of this embodiment, the time at which the pressure receiving plate 127 partitions the detection space in cooperation with the ink guide path 33 can be set to a state where ink of the ink pack 7 is exhausted. Accordingly, as described above, when the liquid container 1 is used as an ink cartridge, the piezoelectric sensor 35 of the ink detection unit 11 can be effectively used as an ink end detection mechanism for detecting that the ink residual quantity of the ink pack 7 becomes zero.

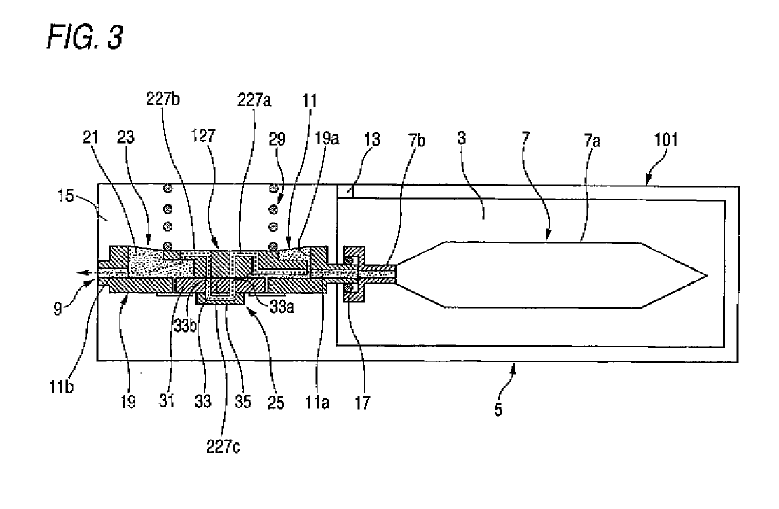

FIG. 3 is a longitudinal cross-sectional view of a liquid container according to a second embodiment of the invention.

A liquid container 101 of the second embodiment uses a pressure receiving plate 227 that is replaced for the pressure receiving plate 127 in the liquid container 1 of the first embodiment. Other parts than the pressure receiving plate 227 are the same as those of the liquid container 1. The same parts are represented by the same reference numerals, and the descriptions thereof will be omitted.

As shown in FIG. 3, in the pressure receiving plate 227 of the liquid container 101 according to the second embodiment, a first flow passage 227a and a second flow passage 227b that are two flow passages connecting the detection space partitioned through the cooperation of the ink guide path 33 to the sensor chamber 21 are provided.

The first flow passage 227a as one of the two flow passages extends to the vicinity of the ink inlet port 11a.

In the liquid container 101 of the second embodiment, when ink is absorbed from the ink supply port 9 to be connected to the ink jet recording apparatus in order to fill ink in the sensor chamber 21, the absorption force reliably exerts action on the ink inlet port 11a through the first flow passage 227a.

Then, ink supplied from the ink pack 7 to the ink inlet port 11a easily flows to the ink guide path 33 through the first flow passage 227a, and the bubbles remaining in the ink guide path 33 are easily eliminated.

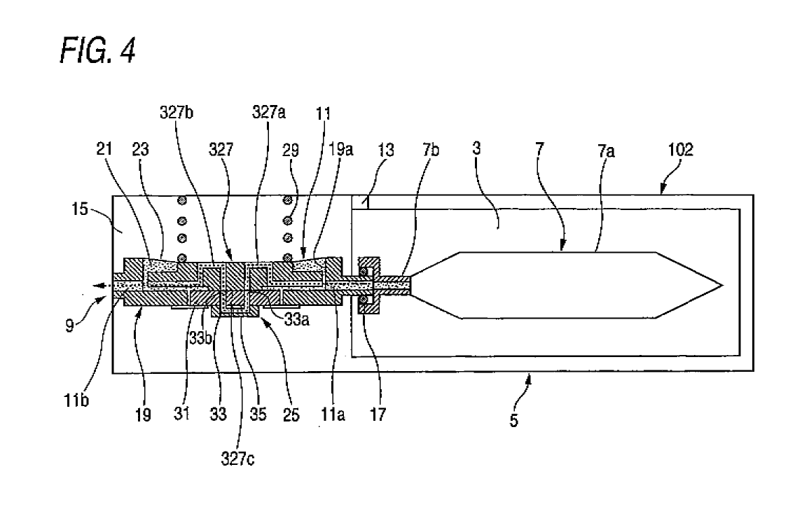

FIG. 4 is a longitudinal cross-sectional view of a liquid container according to a third embodiment of the invention.

A liquid container 102 of the third embodiment uses a pressure receiving plate 327 that is replaced for the pressure receiving plate 127 in the liquid container 1 of the first embodiment. Other parts than the pressure receiving plate 327 are the same as those of the liquid container 1. The same parts are represented by the same reference numerals, and the descriptions thereof will be omitted.

As shown in FIG. 4, in the pressure receiving plate 327 of the liquid container 102 according to the second embodiment, a first flow passage 327a and a second flow passage 327b that are two flow passages connecting the detection space partitioned through the cooperation of the ink guide path 33 to the sensor chamber 21 are provided.

The first flow passage 327a and the second flow passage 327b as the two flow passages extend to the vicinities of the ink inlet port 11a and the ink outlet port lib, respectively.

In the liquid container 102 of the third embodiment, when ink is absorbed from the ink supply port 9 to be connected to the inkjet recording apparatus in order to fill ink in the sensor chamber 21, the absorption force reliably exerts action on the second flow passage 327b through the ink outlet port 11b and on the ink inlet port 11a through the first flow passage 327a.

Then, ink in the ink pack 7 is easily absorbed through the ink guide path 33 connected to the first flow passage 327a and the second flow passage 327b, and the bubbles remaining in the ink guide path 33 are easily eliminated.

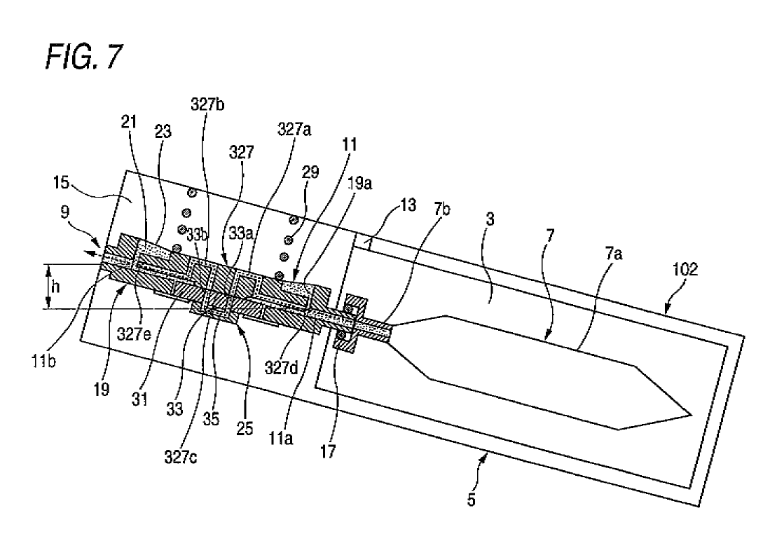

In order to fill ink in the ink detection unit 11 of the liquid container 102 by an ink filling method of the invention (liquid filling method), for example, as shown in FIG. 7, the ink supply port 9 is lifted at an end in a longitudinal direction of the liquid container 102, such that the liquid container 102 is inclined. Then, a difference in height h is secured between an ink inlet port-side opening 327d and an ink outlet port-side opening 327e that are two openings on sides not connected to the ink guide path 33 at the first flow passage 327a and the second flow passage 327b of the pressure receiving plate 327.

That is, when ink is absorbed from the ink supply port 9 to be connected to the ink jet recording apparatus and then is filled in the ink detection unit 11 from the ink pack 7, the ink outlet port-side opening 327e in the vicinity of the ink supply port 9 is made higher than the ink inlet port-side opening 327d in the vicinity of the discharge port 7b.

Then, the ink inlet port-side opening 327d of the pressure receiving plate 327 on a lower side when the ink is filled in the ink guide path 33 becomes an ink inlet port, and a flow direction is made clear. Accordingly, compared with a case where ink is filled when the liquid container 102 is in a horizontal state, the bubble discharge property of the ink detection unit 11 can be improved.

In an ink filling method according to the embodiment of the invention, when ink is filled, the ink outlet port-side opening 327e in the vicinity of the ink supply port 9 is preferably higher than the ink inlet port-side opening 327d in the vicinity of the discharge port 7b. Accordingly, ink may be filled in the ink detection unit 11 in a state where the liquid container 102 is erect such that the ink supply port 9 turns upward.

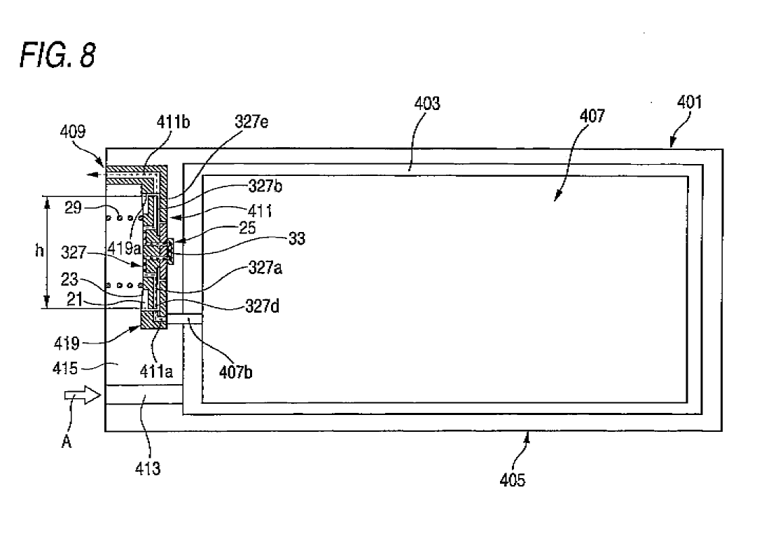

FIG. 8 is a horizontal cross-sectional view of a liquid container according to a fourth embodiment of the invention.

A liquid container 401 of the fourth embodiment uses an ink detection unit 411 that is replaced for the ink detection unit 11 in the liquid container 102 of the third embodiment. Other parts than the arrangement of the ink detection unit 11 are the same as those of the liquid container 102. The same parts are represented by the same reference numerals, and the descriptions thereof will be omitted.

As shown in FIG. 8, in the liquid container 401 of the fourth embodiment, the ink detection unit 411 includes a detection unit case 419 that has a recess space 419a connected to an ink inlet port (liquid inlet port) 411a to be connected to a discharge port 407b of an ink pack 407 and an ink outlet port (liquid outlet port) 411b to be connected to an ink supply port 409 along a transverse direction of a flat rectangular parallelepiped container main body 405 (an up and down direction in FIG. 8), a flexible film 23 that seals an opening of the recess space 419a so as to partition a sensor chamber 21, a pressure detection unit 25 that is provided at the bottom of the recess space 419a, a pressure receiving plate 327 that is fixed to the flexible film 23 to face the pressure detection unit 25, and a compression coil spring 29 that is compressed between the pressure receiving plate 427 and a front wall of a detection unit accommodating chamber 415 so as to elastically urge the pressure receiving plate 427 and the flexible film 23 in a direction in which the volume of the sensor chamber 21 is reduced.

The detection unit case 419 has the L-shaped ink inlet port 411a that is integrally formed at one end of a peripheral wall partitioning the recess space 419a, and the L-shaped ink outlet port 411b that passes through the peripheral wall facing the ink inlet port 411a to be then connected to the ink supply port 409. Then, ink that flows in the sensor chamber 21 from the discharge port 407b of the ink pack 407 is supplied to the recording head from the ink supply port 409, which is offset and opened in the transverse direction of the container main body 405, through the ink outlet port 411b.

The container main body 405 includes a pressure chamber 403 that is in a closed state, a pressure port 413 that serves as a pressurized gas injection portion for allowing a pressure unit (not shown) to send pressurized air to the pressure chamber 403, as indicated by an arrow A, and a detection unit accommodating chamber 415 that accommodates the ink detection unit 411. The detection unit accommodating chamber 415 is a region that is blocked from a pressure of the pressurized gas to be supplied to the pressure chamber 403.

That is, when ink is filled in the ink detection unit 411 of the liquid container 401 according to the fourth embodiment, as shown in FIG. 8, the container main body 405 is erect such that the transverse direction of the container main body 405 becomes perpendicular. Then, a difference in height h between the ink inlet port-side opening 327d and the ink outlet port-opening 327e that are two openings on sides not connected to the ink guide path 33 at the first flow passage 327a and the second flow passage 327b of the pressure receiving plate 327 can be secured.

That is, when ink is absorbed from the ink supply port 409 to be connected to the ink jet recording apparatus and is filled in the ink detection unit 411 from the ink pack 407, the ink outlet port-side opening 327e in the vicinity of the ink supply port 409 becomes higher than the ink inlet port-side opening 327d in the vicinity of the discharge port 497b.

Then, the ink inlet port-side opening 327d of the pressure receiving plate 327 on a lower side when ink is filled in the ink guide path 33 is set as an ink inlet port, and a flow direction is made clear. Further, the bubbles in the sensor chamber 21 move to the upper ink outlet port-side opening 327e by buoyancy. Accordingly, the bubble discharge property of the ink detection unit 411 is improved.

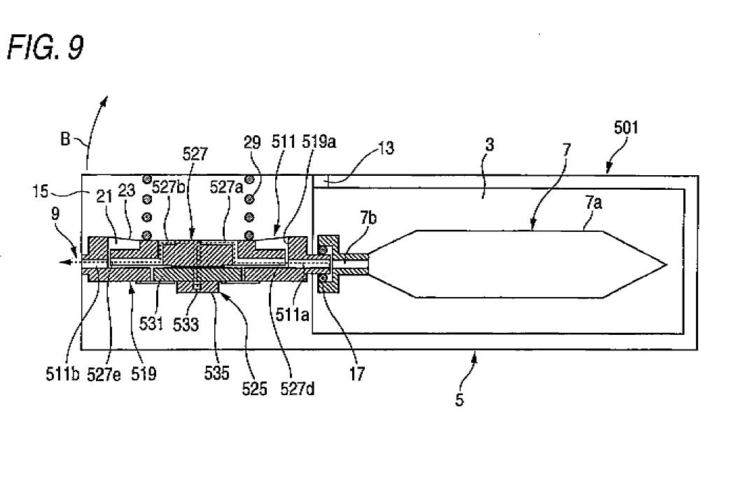

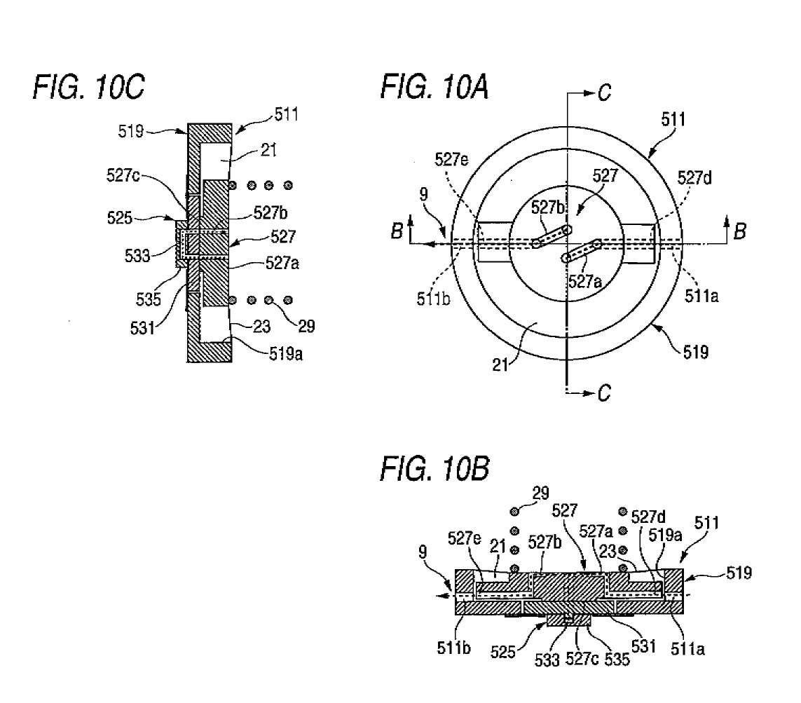

FIG. 9 is a longitudinal cross-sectional view of a liquid container according to a fifth embodiment of the invention. FIGS. 10A to 10C are a plan view and cross-sectional views illustrating an ink detection unit. A liquid container 501 according to the fifth embodiment has the same structure as the liquid container 102 of the third embodiment, except for an ink detection unit 511. The same parts are represented by the same reference numerals, and the descriptions thereof will be omitted.

As shown in FIG. 9, the ink detection unit 511 according to the fifth embodiment has a detection unit case 519 that has a recess space 519a connected to an ink inlet port (liquid inlet port) 511a to be connected to a discharge port 7b of an ink pack 7 and an ink outlet port (liquid outlet port) 511b to be connected to an ink supply port 9, a flexible film 23 that seals an opening of the recess space 519a so as to partition a sensor chamber 21, a pressure detection unit 525 that is provided at the bottom of the recess space 519a, a pressure receiving plate (movable member) 527 that is fixed to the flexible film 23 to face the pressure detection unit 525, and a compression coil spring 29 that is compressed between the pressure receiving plate 527 and an upper wall of a detection unit accommodating chamber 15 so as to elastically urge the pressure receiving plate 527 and the flexible film 23 in a direction in which the volume of the sensor chamber 21 is reduced.

An ink guide path 533 as a recess portion formed at a bottom plate 531 of the pressure detection unit 525 is a flow passage shape having two openings 533a and 533b. In a state where the pressure receiving plate 527 comes into close contact with the bottom plate 531, the ink guide path 533 partitions the detection space in cooperation with one surface 527c of the pressure receiving plate 527. The openings 533a and 533b are connected to a first flow passage 527a and a second flow passage 527b (described below) of the pressure receiving plate 527, respectively. Meanwhile, if the pressure receiving plate 527 is separated from the bottom plate 531, the ink guide path 533 is opened to the sensor chamber 21 through the two openings 533a and 533b. The one surface 527c of the pressure receiving plate 527 is, in a region facing a vibration surface of a piezoelectric sensor 535, substantially in parallel with the vibration surface.

As shown in FIGS. 10A to 10C, in the liquid container 501 of the fifth embodiment, the pressure receiving plate 527 is provided with the two flow passages 527a and 527b that are two flow passages connecting the detection space through the cooperation of the ink guide path 533 to the sensor chamber 21.

The first flow passage 527a and the second flow passage 527b as the two flow passages extend to the vicinities of the ink inlet port 511a and the ink outlet port 511b, respectively.

The ink guide path 533 that is formed at the bottom of the pressure detection unit 525 of this embodiment has a flow passage shape that is connected along the transverse direction of the flat rectangular parallelepiped container main body 5 according to the electrode arrangement of a piezoelectric sensor 535, as shown in FIGS. 10A to 10C.

When ink is filled in the ink detection unit 511 of the liquid container 501 on the basis of the ink filling method of the invention, even though the ink supply port 9 at an end in the longitudinal direction of the liquid container 501 is lifted in a direction of an arrow B and the liquid container 501 is inclined, the two openings 533a and 533b of the ink guide path 533 are horizontal with no difference in height. However, a difference in height between an ink inlet port-side opening 527d and an ink outlet port-side opening 527e that are two openings on sides not connected to the ink guide path 533 at the first flow passage 527a and the second flow passage 527b of the pressure receiving plate 527 can be secured.

That is, when ink is absorbed from the ink supply port 9 to be connected to the ink jet recording apparatus and then is filled in the ink detection unit 511 from the ink pack 7, the ink outlet port-side opening 527e in the vicinity of the ink supply port 9 becomes higher than the ink inlet port-side opening 527d in the vicinity of the discharge port 7b.

Then, the ink inlet port-side opening 527d of the pressure receiving plate 527 on a lower side when ink is filled in the ink guide path 533 is set to as a liquid inlet port, and a flow direction is made clear. Therefore, the bubble discharge property of the ink guide path 533 is set as a liquid inlet port, and a flow direction is made clear. As a result, the bubble discharge property of the ink guide path 533 that is in the horizontal state can be secured.

In each of the above-described embodiments, as the urging unit that urges the flexible film 23 and the pressure receiving plate 127 (227, 327) toward the piezoelectric sensor 35, the compression coil spring 29 is used.

However, instead of the compression coil spring 29, an urging unit formed of a different elastic member, such as rubber or the like, may be used.

In each of the above-described embodiments, the time at which the pressure receiving plate 127 (227, 327) partitions the detection space in cooperation with the ink guide path 33 is set to a state where ink of the ink pack 7 is completely exhausted, and thus the piezoelectric sensor 35 functions as an ink end detection mechanism for detecting that the ink residual quantity in the ink pack 7 becomes zero.

However, if the time at which the pressure receiving plate 127 (227, 327) partitions the detection space in cooperation with the ink guide path 33 is set to a state where ink of the ink pack 7 is nearly exhausted (a state where predetermined small amount remains), the piezoelectric sensor 35 may function as an ink end detection mechanism for detecting that the ink residual quantity in the ink pack 7 becomes zero soon.

In the liquid container of each of the above-described embodiments of the invention, the recess portion that partitions the detection space in cooperation with one surface of the movable member and serves as the vibration reaction region, to which the vibration is applied by the pressure detection unit, is not limited to the ink guide path 33 having the two openings 33a and 33b shown in each of the embodiments of the invention. The recess portion shown in each of the embodiments of the invention may be a simple notch shape that is opened at the upper surface of the bottom plate 31, not a pipy flow passage.

A liquid container according to another embodiment of the invention will now be described in detail with reference to the accompanying drawings.

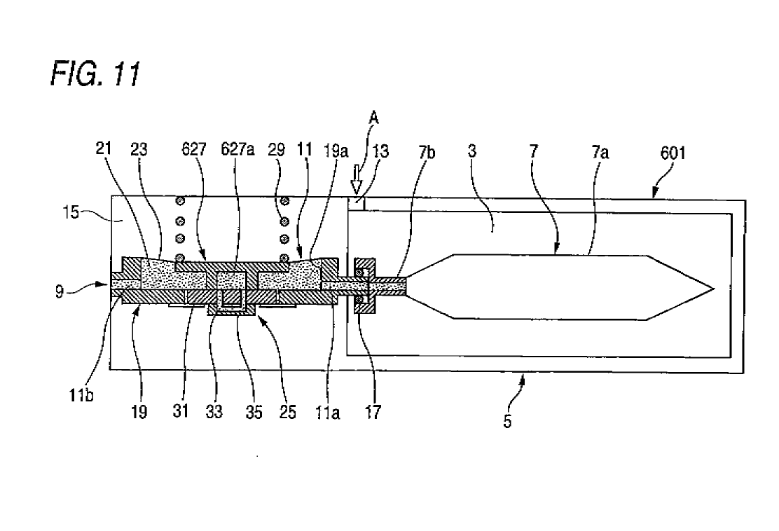

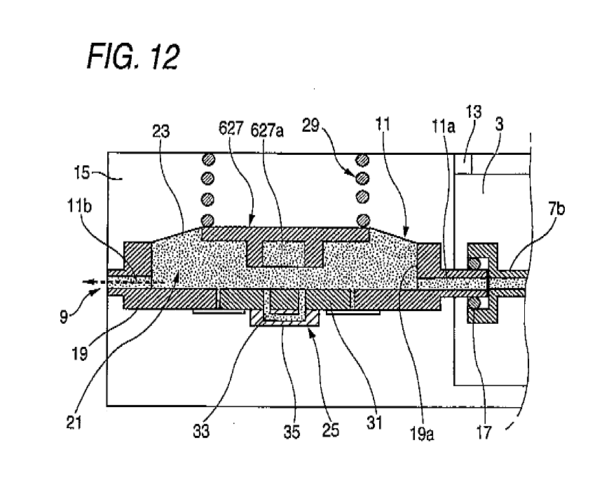

FIG. 11 is a longitudinal cross-sectional view of a liquid container according to a sixth embodiment of the invention. FIG. 11 shows a state where the liquid containing amount of the liquid detection chamber becomes a predetermined amount or less. FIG. 12 is a longitudinal cross-sectional view showing a case where the liquid containing portion of the liquid container shown in FIG. 11 is pressurized.

A liquid container 601 of the sixth embodiment is an ink cartridge that is detachably mounted on a cartridge mounting portion of an ink jet recording apparatus (liquid consuming apparatus) (not shown) and supplies ink (liquid) to a printing head provided in the recording apparatus.

As shown in FIG. 11, the liquid container 1 includes a container main body 5 that partitions a pressure chamber 3 to be pressurized by a pressure unit (not shown), an ink pack (liquid containing portion) 7 that stores ink, is accommodated in the pressure chamber 3, and discharges ink stored therein from an ink discharge port (liquid discharge port) 7b by a pressure of the pressure chamber 3, an ink supply port (liquid supply port) 9 that supplies ink to a printing head of the ink jet recording apparatus as an external liquid consuming apparatus, and an ink detection unit (liquid detection unit) 11 that is interposed between the ink pack 7 and the ink supply port 9 and detect the ink residual quantity.

The container main body 5 is a casing that is integrally formed of resin. The container main body 5 includes the pressure chamber 3 that is in a closed state, a pressure port 13 that serves as a pressurized gas injection portion for allowing the pressure unit (not shown) to send pressurized air to the pressure chamber 3, as indicated by an arrow A, and a detection unit accommodating chamber 15 that accommodates the ink detection unit 11. The detection unit accommodating chamber 15 is a region that is blocked from a pressure of the pressurized gas to be supplied to the pressure chamber 3.

The container main body 5 is not necessarily a resin member integrally formed insofar as the pressure chamber 3 can be in the closed state.

The ink pack 7 has a flexible pouch body 7a that is formed by attaching edges of aluminum-laminated multilayer films, on which an aluminum layer is laminated on a flexible resin film, to each other. A cylindrical discharge port 7b, to which an ink inlet port (liquid inlet port) 11a of the ink detection unit 11 is connected, is bonded to one end of the flexible pouch body 7a. The ink pack 7 is formed of the aluminum-laminated multilayer film, thereby ensuring a high gas barrier property.

The ink pack 7 and the ink detection unit 11 are connected to each other by engaging the ink inlet port 11a with the discharge port 7b. That is, the ink pack 7 and the ink detection unit 11 can be detached from each other by releasing the engagement of the discharge port 7b and the ink inlet port 11a.

A packing 17 that connects the discharge port 7b and the ink inlet port 11a to each other airtight is provided in the discharge port 7b. In the ink pack 7, ink that is adjusted in advance at a high degree of deaeration before the ink detection unit 11 is connected is filled.

The ink detection unit 11 includes a detection unit case 19 that has a recess space 19a connecting the ink inlet port 11a connected to the discharge port 7b of the ink pack 7 and an ink outlet port (liquid outlet port) 11b connected to the ink supply port 9, a flexible film 23 that seals an opening the recess space 19a so as to partition a sensor chamber (liquid detection chamber) 21, a pressure detection unit 25 that is provided at the bottom of the recess space 19a, a pressure receiving plate (movable member) 627 that is fixed to the flexible film 23 to face the pressure detection unit 25, and a compression coil spring (urging member) 29 that is compressed between the pressure receiving plate 627 and an upper wall of the detection unit accommodating chamber 15 and elastically urges the pressure receiving plate 627 and the flexible film 23 in a direction in which the volume of the sensor chamber 21 is reduced.

In the detection unit case 19, the ink inlet port 11a is integrally formed at one end of peripheral wall partitioning the recess space 19a, and the ink outlet port 11b that is connected to the ink supply port 9 is formed to pass through the peripheral wall facing the ink inlet port 11a. Though not shown, a valve mechanism is provided in the ink supply port 9. The valve mechanism opens a flow passage when the ink cartridge is mounted on the cartridge mounting portion of the ink jet recording apparatus and an ink supply needle provided in the cartridge mounting portion is inserted into the ink supply port 9.

The pressure detection unit 25 of the ink detection unit 11 includes a bottom plate 31 that comes into close contact with the pressure receiving plate 627 by an urging force of the compression coil spring 29 when ink is not derived from the ink pack 7 to the ink supply port 9, an ink guide path 33 that is a recess portion formed in the bottom plate 31, a recess 627a that is provided in the pressure receiving plate 627 so as to form partition the detection space in cooperation with the ink guide path 33, and a piezoelectric sensor (piezoelectric detection unit) 35 that applies vibration to the ink guide path 33 and detects a free vibration state according to the vibration.

The piezoelectric sensor 35 can detect different free vibration states (a change in amplitude or frequency of the residual vibration) according to whether or not the ink guide path 33 is covered with the pressure receiving plate 627, For example, a control unit that is provided in the ink jet recording apparatus can detect a pressure in the sensor chamber 21 by detecting deformation of the flexible film 23 that is supporting the pressure receiving plate 627 according to the free vibration state detected by the piezoelectric sensor 35.

An urging direction of the compression coil spring 29 is a direction in which the volume of the sensor chamber 21 is reduced, as described above, and a direction in which the piezoelectric sensor 35 is disposed.

The ink guide path 33 is a recess portion formed in the bottom plate 31. As shown in FIG. 11, in a state where the pressure receiving plate 627 comes into close contact with the bottom plate 31, the ink guide path 33 partitions the detection space in cooperation with the recess 627a of the pressure receiving plate 627. Meanwhile, as shown in FIG. 12, if the pressure receiving plate 627 is separated from the bottom plate 31, the ink guide path 33 is opened to the sensor chamber 21. The pressure receiving plate 627 has, in a region facing a vibration surface of the piezoelectric sensor 35, a surface that is substantially in parallel with the vibration surface.

As shown in FIG. 12, if ink is supplied from the ink pack 7 to the sensor chamber 21 due to a pressure of the ink pack 7 by pressurized air to be supplied to the pressure chamber 3, in the ink detection unit 11, the flexible film 23 is swelled and deformed upward according to a change in ink containing amount (liquid level) in the sensor chamber 21 accordingly. With the deformation of the flexible film 23, the pressure receiving plate 627 that forms a portion of a partition of the sensor chamber 21 moves upward, and the pressure receiving plate 627 is separated from the bottom plate 31. If the pressure receiving plate 627 is separated from the bottom plate 31, the ink guide path 33 is opened to the sensor chamber 21, and then ink is supplied from the ink supply port 9 to the recording head through the sensor chamber 21.

Even though a predetermined pressure is applied to the pressure chamber 3, if ink contained in the ink pack 7 decreases, the amount of ink to be supplied from the ink pack 7 to the sensor chamber 21 decreases. Accordingly, the pressure in the sensor chamber 21 decreases, and thus the pressure receiving plate 627 approaches the bottom plate 31 having the ink guide path 33.

In this embodiment, the pressure receiving plate 627 comes into contact with the bottom plate 31 by the decrease in pressure of the sensor chamber 21, and a time at which the recess 627a partitions the detection space in cooperation with the ink guide path 33 is set to a state where ink of the ink pack 7 is exhausted.

The flexible film 23 functions as a diaphragm that applies displacement to the pressure receiving plate 627 according to a pressure of ink to be supplied to the sensor chamber 21. In order to detect a minute change in pressure of ink and to improve detection precision, the flexible film 23 preferably has sufficient flexibility.

In the above-described liquid container 601 of this embodiment, if the ink containing amount (liquid containing amount) of the sensor chamber 21 becomes the predetermined amount or less, the recess 627a of the pressure receiving plate 627 partitions the detection space serving as the vibration reaction region in cooperation with the ink guide path 33. Accordingly, a frequency having acoustic impedance corresponding to the total volume of the ink guide path 33 and the recess 627a appears. This frequency becomes a frequency lower than a frequency by acoustic impedance when the pressure receiving plate 627 is separated from the bottom plate 31, and a difference markedly appears.

Therefore, the change in free vibration state to be detected by the piezoelectric sensor 35, and the time or state that the liquid containing amount of the sensor chamber 21 reaches a predetermined level can be accurately and reliably detected.

The ink guide path 33 provided in the sensor chamber 21 partitions the detection space in cooperation with the recess 627a provided in the pressure receiving plate 627 so as to increase the volume of the detection space. Accordingly, there is no case where the residual vibration becomes small due to an insufficient volume of the vibration reaction region and the detection is impossible, or, even though the detection is possible, a difference cannot be distinguished due to a slight difference in frequency when it is opened in the sensor chamber 21 and when it is blocked.

That is, the volume of the detection space as the vibration reaction region changes due to the movement of the pressure receiving plate 627, and the acoustic impedance varies. Therefore, by detecting the difference in frequency of the residual vibration, it is possible to detect with high precision that the ink residual quantity in the sensor chamber 21 reaches the predetermined level.

As a result, the liquid container 601 of this embodiment can have a function of detecting that the ink residual quantity reaches the predetermined amount.

In the liquid container 601 of this embodiment, the sensor chamber 21 is configured by sealing the opening formed at the upper surface with the flexible film 23 that is deformable according to the ink containing capacity. The piezoelectric sensor 35 is disposed at the bottom of the sensor chamber 21.

For this reason, the sensor chamber 21 can he easily deformed corresponding to the change in liquid containing amount (a change in pressure), and can be easily configured as a closed space. In addition, ink leakage can be prevented with a simple structure.

In the liquid container 601 of this embodiment, the pressure receiving plate 627 is fixed to the flexible film 23, and moves by the deformation of the flexible film 23 corresponding to the change in liquid containing amount of the sensor chamber 21.

With the easy deformation of the flexible film 23, the pressure receiving plate 627 can smoothly follow the liquid level or pressure.

In the liquid container 601 of this embodiment, the pressure receiving plate 627 has, in the region facing the vibration surface of the piezoelectric sensor 35, a surface that is substantially in parallel with the vibration surface. Accordingly, the detection space whose volume changes according to the liquid level can be easily formed.

In the liquid container 601 of this embodiment, the pressure receiving plate 627 is urged by the compression coil spring 29 as the urging unit formed of an elastic member in the direction in which the piezoelectric sensor 35 is disposed.

By adjusting the urging force of the compression coil spring 29, the time at which the recess 627a of the pressure receiving plate 627 partitions the detection space in cooperation with the ink guide path 33 can be arbitrarily changed, and simultaneously an internal pressure (liquid residual quantity) of the sensor chamber 21 to be detected can be easily set.

In the liquid container 601 of this embodiment, the time at which the recess 627a of the pressure receiving plate 627 partitions the detection space in cooperation with the ink guide path 33 can be set to a state where ink of the ink pack 7 is exhausted. Accordingly, as described above, when the liquid container 1 is used as an ink cartridge, the piezoelectric sensor 35 of the ink detection unit 11 can be effectively used as an ink end detection mechanism for detecting that the ink residual quantity of the ink pack 7 becomes zero.

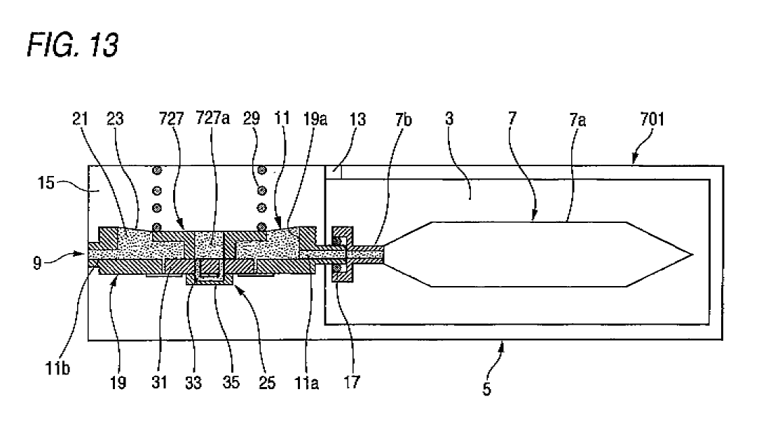

FIG. 13 is a longitudinal cross-sectional view of a liquid container according to a seventh embodiment of the invention.

As shown in FIG. 13, in a liquid container 701 of the seventh embodiment, the improvement of a portion of the liquid container 601 shown in FIG. 11 is made. Specifically, an opening passing through a pressure receiving plate 727 is blocked by a flexible film 23 to which the pressure receiving plate 727 is fixed, thereby forming a recess 727a. Other parts are the same as those of the liquid container 601 shown in FIG. 11. The same parts are represented by the same reference numerals, and the descriptions thereof will be omitted.

The flexible film 23 is a so-called elastic member, and thus, in the liquid container 701 of the seventh embodiment, the recess 727a of the pressure receiving plate 727 has one surface formed of an elastic member.

Therefore, according to the liquid container 701 of the seventh embodiment, in the detection space that is partitioned by the ink guide path 33 of the sensor chamber 21 in cooperation with the recess 727a of the pressure receiving plate 727, the attenuation of the residual vibration is suppressed by a volume change characteristic (compliance) due to elastic deformation of the flexible film 23 forming one surface of the recess 727a. As a result, the amplitude of the residual vibration can be easily detected, and the detection precision can be improved.

As the elastic member for securing the compliance in the recess 727a, instead of using the flexible film 23 described above, the pressure receiving plate itself may be formed of rubber or plastic having elasticity,

However, like the pressure receiving plate 727 of this embodiment, when the flexible film 23 is used as an elastic member forming the wall surface of the recess 727a, as shown in FIG. 13, the recess 727a that secures a volume change characteristic (compliance) can be simply formed only by blocking an opening formed to pass through the plate-shaped pressure receiving plate 727 with the flexible film 23 as the elastic member, thereby improving productivity.

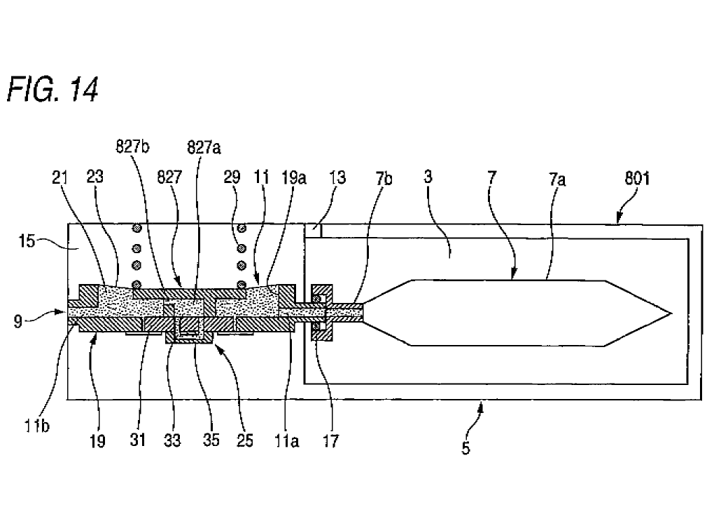

FIG. 14 is a longitudinal cross-sectional view of a liquid container according to an eighth embodiment of the invention.

As shown in FIG. 14, in a liquid container 801 of the eighth embodiment, the improvement of a portion of the liquid container 601 shown in FIG. 11 is made. Specifically, in a single recess 827a that is formed in a pressure receiving plate 827, a connection path 827b that connects the sensor chamber 21 and the recess 827a at the liquid outlet port 11b is additionally formed. Except that the connection path 827b is added, other parts are the same as those of the liquid container 601 shown in FIG. 11. The same parts are represented by the same reference numerals, and the descriptions thereof will be omitted.

According to the liquid container 801 of the eighth embodiment, the recess 827a formed in the pressure receiving plate 827 is connected to the sensor chamber 21, which is a liquid space having a large volume, by the connection path 827b. Accordingly, unlike the pressure receiving plate 727 in the seventh embodiment, instead of securing the compliance by forming one surface of the recess 727a with the flexible film 23 as the elastic member, the amplitude of the residual vibration upon detection can be secured by suppressing the attenuation of the residual vibration of the detection space partitioned by the ink guide path 33 in cooperation with the recess 827a.

Then, the attenuation of the residual vibration of the detection space partitioned by the ink guide path 33 of the sensor chamber 21 in cooperation with the recess 827a of the pressure receiving plate 827 is suppressed. Therefore, the amplitude of the residual vibration can be easily detected, and thus the detection precision can be further improved.

As a result, the liquid container 801 of this embodiment can have a function of detecting that the ink residual quantity becomes a predetermined amount.

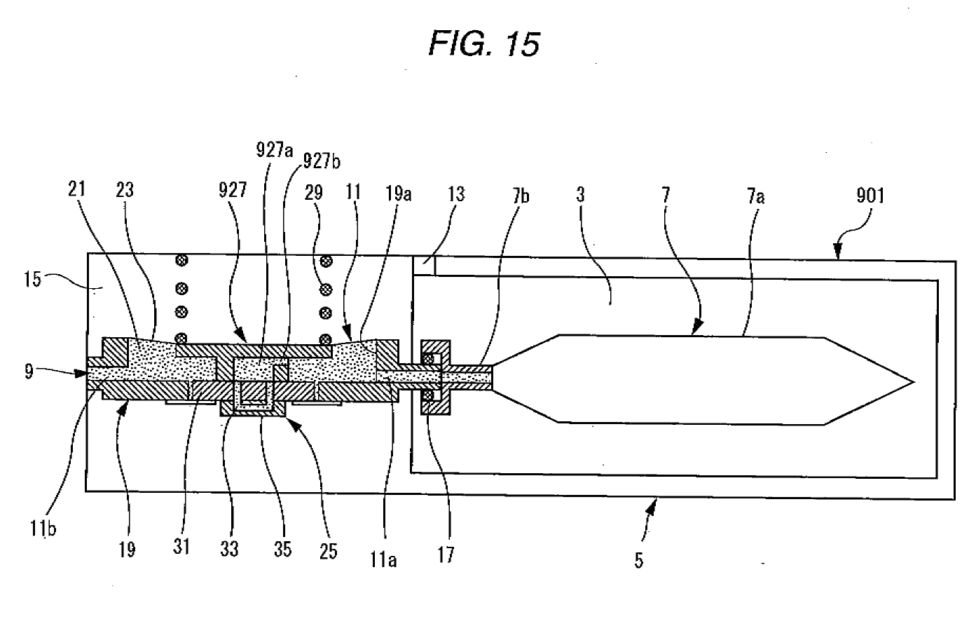

FIG. 15 is a longitudinal cross sectional view of a liquid container according to a ninth embodiment of the invention.

As shown in FIG. 15, in a liquid container 901 of the ninth embodiment, the improvement of a portion of the liquid container 601 shown in FIG. 11 is made. Specifically, in a single recess 927a that is formed in a pressure receiving plate 927, a connection path 927b that connects the sensor chamber 21 and the recess 927a at the liquid inlet port 11a is additionally formed. Except that the connection path 927b is added, other parts are the same as those of the liquid container 601 shown in FIG. 11 The same parts are represented by the same reference numerals, and the descriptions thereof will be omitted.

According to the liquid container 901 of the ninth embodiment, the recess 927a formed in the pressure receiving plate 927 is connected to the sensor chamber 21, which is a liquid space having a large volume, by the connection path 927b. Accordingly, unlike the pressure receiving plate 727 in the seventh embodiment, instead of securing the compliance by forming one surface of the recess 727a with the flexible film 23 as the elastic member, the amplitude of the residual vibration upon detection can be secured by suppressing the attenuation of the residual vibration of the detection space partitioned by the ink guide path 33 in cooperation with the recess 927a.

Then, the attenuation of the residual vibration of the detection space partitioned by the ink guide path 33 of the sensor chamber 21 in cooperation with the recess 927a of the pressure receiving plate 927 is suppressed. Therefore, the amplitude of the residual vibration can be easily detected, and thus the detection precision can be further improved.

As a result, the liquid container 901 of this embodiment can have a function of detecting that the ink residual quantity becomes a predetermined amount.

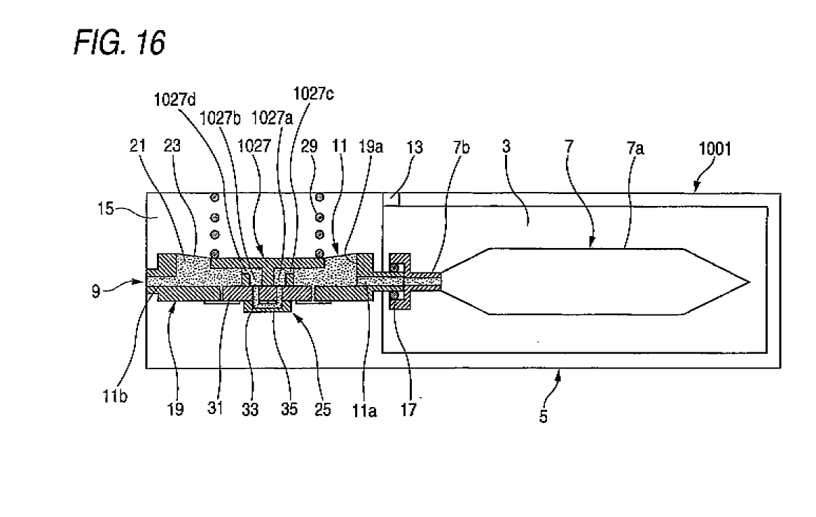

FIG. 16 is a longitudinal cross-sectional view of a liquid container according to a tenth embodiment of the invention.

As shown in FIG. 16, in a liquid container 1001 of the tenth embodiment, the improvement of a portion of the liquid container 601 shown in FIG. 11 is made. In a pressure receiving plate 1027, two recesses 1027a and 1027b are provided so as to partition the detection space in cooperation with the ink guide path 33, and connection paths 1027c and 1027d that connect the recesses 1027a and 1027b to the sensor chamber 21 are provided in the recesses 1027a and 1027b, respectively. Other parts than the pressure receiving plate 1027 are the same as those of the liquid container 601 shown in FIG. 11. The same parts are represented by the same reference numerals, and the descriptions thereof will be omitted.

In the liquid container 1001 of the tenth embodiment, the two recesses 1027a and 1027b formed in the pressure receiving plate 1027 serve as two flow passages that connect the detection space partitioned through the cooperation of the ink guide path 33 serving as the recess portion to the sensor chamber 21 through the connection paths 1027c and 1027d, respectively.

Accordingly, the ink guide path 33 provided in the sensor chamber 21 partitions the detection space in cooperation with the two recesses 1027a and 1027b provided in the pressure receiving plate 1027 so as to increase the volume of the detection space. Therefore, there is no case where the residual vibration becomes small due to an insufficient volume of the vibration reaction region and the detection is impossible, or, even though the detection is possible, a difference cannot be distinguished due to a slight difference in frequency when it is opened in the sensor chamber 21 and when it is blocked.

That is, the two recesses 1027a and 1027b formed in the pressure receiving plate 1027 is connected to the sensor chamber 21, which is a liquid space having a large volume, through the connection paths 1027c and 1027d, respectively. Accordingly, the amplitude of the residual vibration upon detection can be secured by suppressing the attenuation of the residual vibration of the detection space partitioned by the ink guide path 33 in cooperation with the recesses 1027a and 1027b.

When ink is absorbed from the ink supply port 9 to be connected to the ink jet recording apparatus in order to fill ink in the sensor chamber 21, an absorption force exerts action on the discharge port 7b of the ink pack 7 connected to the sensor chamber 21 through the connection path 1027d, the recess 1027b, the ink guide path 33, the recess 1027a, and the connection path 1027c formed in the pressure receiving plate 1027, and then ink is supplied to the ink supply port 9 while going back the flow passage on which the absorption force exerts action.

That is, ink is reliably filled in the ink guide path 33 as the vibration reaction region, and bubbles do not remain in the ink guide path 33. Therefore, detection precision can be prevented from being degraded due to remaining bubbles.

Therefore, the liquid container 1001 of this embodiment can have a function of detecting that the ink residual quantity becomes a predetermined amount. In addition, even when the ink guide path 33 has a shape in which it is difficult to fill inks ink can be reliably filled, and the ink containing amount can be detected with high precision.

The structures of the liquid detection unit, the liquid detection chamber, the movable member, the recess portion, the recess, the piezoelectric detection unit, and the like in the liquid container of the invention are not limited to the structures in each of the above-described embodiments, but various shapes can be used on the basis of the spirit of the invention.

In each of the above-described embodiments, the compression coil spring 29 is used as the urging unit that urges the flexible film 23 and the pressure receiving plate 627 (727, 827, 927, 1027) toward the piezoelectric sensor 35.

However, instead of the compression coil spring 29, an urging unit formed of a different elastic member, such as rubber or the like, may be used.

In each of the above-described embodiments, the time at which the pressure receiving plate 627 (727, 827, 927, 1027) partitions the detection space in cooperation with the ink guide path 33 is set to a state where ink of the ink pack 7 is completely exhausted, and thus the piezoelectric sensor 35 functions as an ink end detection mechanism for detecting that the ink residual quantity in the ink pack 7 becomes zero.

However, if the time at which the pressure receiving plate 627 (727, 827, 927, 1027) partitions the detection space in cooperation with the ink guide path 33 is set to a state where ink of the ink pack 7 is nearly exhausted (a state where predetermined small amount remains), the piezoelectric sensor 35 may function as an ink end detection mechanism for detecting that the ink residual quantity in the ink pack 7 becomes zero soon.

In the liquid container of each of the above-described embodiments of the invention, the recess portion that partitions the detection space in cooperation with the recess of the movable member and serves as the vibration reaction region, to which the vibration is applied by the pressure detection unit, is not limited to the ink guide path 33 having the two openings 33a and 33b shown in each of the embodiments of the invention. The recess portion shown in each of the embodiments of the invention may be a simple notch shape that is opened at the upper surface of the bottom plate 31, not a pipy flow passage.

A liquid container according to an eleventh embodiment of the invention will now be described in detail with reference to the accompanying drawings.

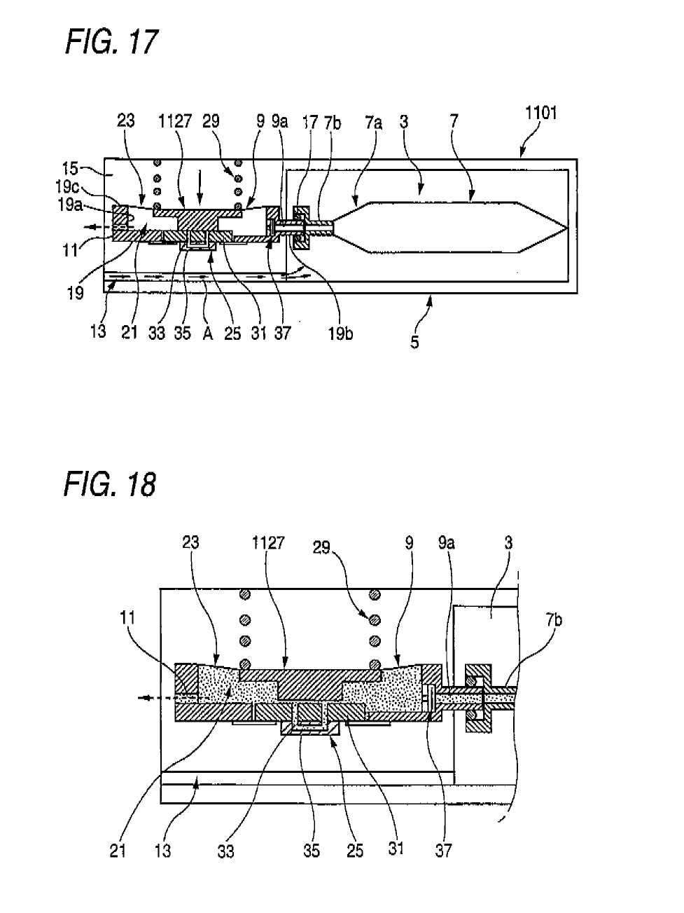

FIG. 17 is a longitudinal cross-sectional view of a liquid container according to the eleventh embodiment of the invention. FIG. 18 is an enlarged cross-sectional view showing the operation when the liquid of the liquid detection unit shown in FIG. 11 is derived.

A liquid container 1101 of the eleventh embodiment is an ink cartridge that is detachably mounted on a cartridge mounting portion of an ink jet recording apparatus (not shown) and supplies ink to a printing head provided in the recording apparatus.

As shown in FIG. 17, the liquid container 1101 has a container main body 5 that partitions a pressure chamber 3, an ink pack (liquid containing portion) 7 that stores ink and is accommodated in the pressure chamber 3, an ink detection unit (liquid detection unit) 9 that has a flow passage 9a to be connected to the ink pack 7, and an ink derivation port (liquid derivation portion) 11 that derives ink in the ink pack to a printing head as a liquid ejecting head.

The container main body 5 is a casing that is integrally formed of resin. The container main body 5 includes the pressure chamber 3 that is in a closed state, a pressure port 13 that serves as a pressurized gas injection portion for allowing the pressure unit (not shown) to send pressurized air to the pressure chamber 3, as indicated by an arrow A, and a detection unit accommodating chamber 15 that accommodates the ink detection unit 9. The detection unit accommodating chamber 15 is a region that is blocked from a pressure of the pressurized gas to be supplied to the pressure chamber 3.

The ink pack 7 has a flexible pouch body 7a that is formed by attaching edges of aluninum-laminated multilayer films, on which an aluminum layer is laminated on a flexible resin film, to each other. A cylindrical ink supply port 7b, to which the flow passage 9a of the ink detection unit 9 is connected, is bonded to one end of the flexible pouch body 7a. The ink pack 7 is formed of the aluminum-laminated multilayer film, thereby ensuring a high gas barrier property.

The ink pack 7 and the ink detection unit 9 are connected to each other by engaging the flow passage 9a with the ink supply port 7b. That is, the ink pack 7 and the ink detection unit 9 can be detached from each other by releasing the engagement of the ink supply port 7b and the flow passage 9a.

A packing 17 that connects the ink supply 7b and a pipe 19b serving the flow passage 9a to each other airtight is provided in the ink supply port 7b.

In the ink pack 7, ink that is adjusted in advance at a high degree of deaeration before the ink detection unit 9 is connected is filled.

The high degree of deaeration means a state that has a dissolved gas amount smaller than a dissolved gas amount (a dissolved gas amount in a saturation state) under an atmospheric pressure at a normal temperature (25° C,) by 20%.

As regards ink that is used in the ink jet recording apparatus, if the nitrogen content in the saturation state is about 10 PPM, the state where the degree of deaeration is kept refers to a state where the dissolved nitrogen content is 8 PPM or less.

The ink detection unit 9 includes a detection unit case 19 that has a recess space 19a connecting the flow passage 9a and the ink derivation port 11, a flexible film 23 that seals an opening the recess space 19a so as to partition a sensor chamber 21, a pressure detection unit 25 that is provided at the bottom of the recess space 19a, a pressure receiving plate (movable member) 1127 that is supported on the flexible film 23 to face the pressure detection unit 25, and a compression coil spring (urging member) 29 that is compressed between the pressure receiving plate 1127 and an upper wall of the detection unit accommodating chamber 15 and elastically urges the pressure receiving plate 1127 and the flexible film 23 in a direction in which the volume of the sensor chamber 21 is reduced.

In the detection unit case 19, the pipe 19b serving the flow passage 19a is integrally formed at one end of a peripheral wall 19c partitioning the recess space 19a, and the ink derivation port 11 is formed to pass through the peripheral wall 19c facing the pipe 19b. Though not shown, a valve mechanism is provided in the ink derivation port 11. The valve mechanism opens a flow passage when the ink cartridge is mounted on the cartridge mounting portion of the ink jet recording apparatus and an ink supply needle provided in the cartridge mounting portion is inserted into the ink derivation port 11.

The pressure detection unit 25 of the ink detection unit 9 includes a bottom plate 31 that comes into close contact with the pressure receiving plate 1127 by an urging force of the compression coil spring 29 when ink is not derived from the ink pack 7 to the ink derivation port 11, an ink guide path 33 that is formed to pass through the bottom plate 31 and is connected to the sensor chamber 21 if the pressure receiving plate 1127 is separated from the bottom plate 31, as shown in FIG. 18, and a piezoelectric sensor 35 that applies vibration to the ink guide path 33 and detects a free vibration state according to the vibration.

As shown in FIG. 18, if ink is supplied from the ink pack 7 to the sensor chamber 21 due to a pressure of the ink pack 7 by pressurized air to be supplied to the pressure chamber 3, in the ink detection unit 11, the flexible film 23 is swelled and deformed upward by the pressure of ink. With the deformation of the flexible film 23, the pressure receiving plate 1127 moves upward, and the pressure receiving plate 627 is separated from the bottom plate 31. Then, the ink guide path 33 is connected to the sensor chamber 21.

The piezoelectric sensor 35 can detect different free vibration states between a state where the ink guide path 33 is closed with the pressure receiving plate 1127 and a state where the ink guide path 33 is connected to the sensor chamber 21.

Accordingly, for example, a control unit that is provided in the ink jet recording apparatus can detect the pressure in the sensor chamber 21 by detecting deformation of the flexible film 23 that is supporting the pressure receiving plate 1127 according to the free vibration state detected by the piezoelectric sensor 35.

The flexible film 23 functions as a diaphragm that applies displacement to the pressure receiving plate 627 according to a pressure of ink to be supplied to the sensor chamber 21. In order to detect a minute change in pressure of ink and to improve detection precision, the flexible film 23 preferably has sufficient flexibility. In this case, however, the gas barrier property is degraded.

Therefore, the gas barrier property of the ink detection unit 9 is lower than the ink pack 7.

In a state where the pressure by pressurized gas against the ink pack 7 is constant, if the ink residual quantity of the ink pack 7 becomes small, the derivation amount of ink to the sensor chamber 21 in the ink detection unit 9 decreases, and the pressure in the sensor chamber 21 decreases. Accordingly, the ink residual quantity in the ink pack 7 can be calculated from the change in pressure of the sensor chamber 21.

In this embodiment, in the flow passage 9a connected to the ink pack 7 of the ink detection unit 9, an on/off valve 37 that opens/closes the flow passage 9a is provided. As the on/off valve 37,a check valve that opens a flow of a derivation direction of ink to the printing head, and closes a reverse flow is used.

In the above-described liquid container 1101 of this embodiment, when ink in the ink pack 7 is not derived to the printing head, the on/off valve 37 provided in the flow passage 9a between the ink detection unit 9 and the ink pack 7 is closed so as to block between the ink pack 7 and the ink detection unit 9. Accordingly, ink or gas can be prevented from flowing back in the ink pack 7 from the ink detection unit 9.

For this reason, even though the gas barrier property of the ink detection unit 9 is lower than the ink pack 7, there is no case where the degree of deaeration of ink in the ink pack 7 is degraded due to a back flow of gas entering the ink detection unit 9 or the like.

Therefore, the ink detection unit 9 can improve the residual quantity detection precision using the flexible film 23 having excellent flexibility without concern for the degradation of the gas barrier property, can secure excellent the residual quantity detection precision, and can prevent the degradation of the degree of deaeration of ink in the ink pack 7.

In this embodiment, the on/off valve 37 as the check valve may have a structure in which an opening of the flow passage 9a between the ink detection unit 9 and the ink pack 7 is sealed with an urging force by the flow of ink from the ink detection unit 9. For example, the on/off valve 37 can be implemented by a simple structure using a thin plate-shaped valve body. Therefore, the degradation of the degree of deaeration of ink in the ink pack 7 can be prevented at low cost.

In this embodiment, the ink pack 7 and the ink detection unit 9 are separable from each other, and the on/off valve 37 is provided in the flow passage 9a close to the ink detection unit 9 connected to the ink pack 7. Accordingly, the ink pack 7 is an independent part that has no relation with the provision of the on/off valve 37. Therefore, the use of an ink pack for a known liquid container that is not provided with the on/off valve 37 between the ink detection unit 9 and the ink pack 7 is possible, and the development of the liquid container becomes easy.

In this embodiment, the sensor chamber 21 in the ink detection unit 9 is configured by sealing the opening of the recess portion 19a provided in the detection unit case 19 forming the ink detection unit 9 with the flexible film 23, and the flexible film 23 functions as a diaphragm that is deformed by the change in pressure of the ink detection unit 9. Therefore, the structure of the ink detection unit 9 can be simplified.

In this embodiment, the flexible film 23 that functions as the diaphragm is urged by the compression coil spring 29, which is elastically deformable by a pressure of ink flowing from the ink pack 7, in a direction in which the volume of the ink detection unit 9 is reduced. Therefore, the deformation of the diaphragm with respect to the change in pressure of the ink detection unit 9 becomes accurate, and reliability of a residual quantity detection operation can be improved.

In this embodiment, the ink pack 7 is a flexible pouch that is formed by attaching flexible films, and the flexible films are multilayer films including an aluminum layer. Accordingly, the ink pack 7 can have flexibility such that ink therein is easily pressed out to the last, and a high gas barrier property to such an extent that the degree of deaeration can be prevented from being degraded. Therefore, it is possible to implement a good ink pack 7 in which a waste due to an unused liquid is small, and the degree of deaeration of stored ink is suppressed from being degraded.

According to the liquid container 1101 of this embodiment, an ink cartridge that can suppress the degree of deaeration of ink stored in the ink pack 7 from being degraded, and can detect the ink residual quantity in the ink pack 7 with high precision can be mounted on the ink jet recording apparatus.

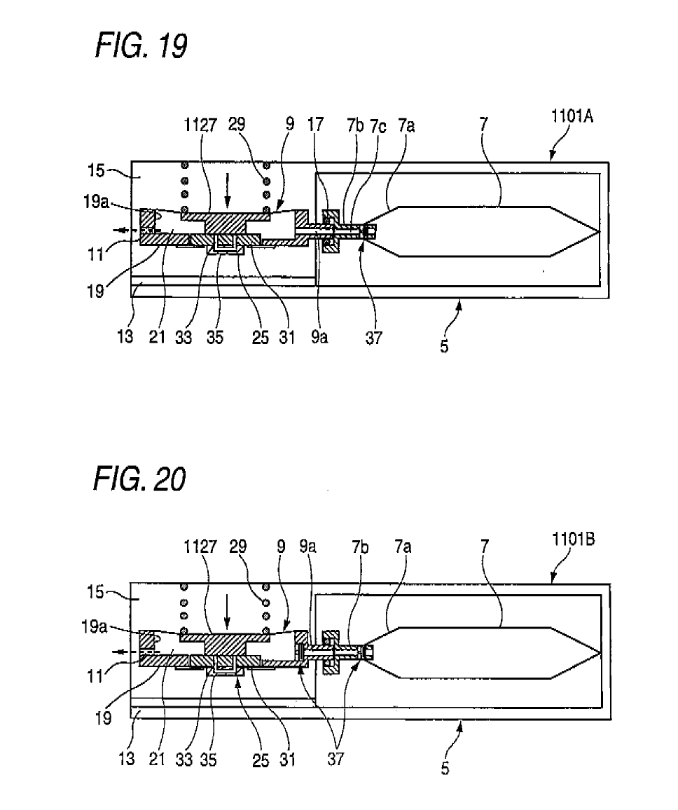

FIG. 19 shows a liquid container according to a twelfth embodiment of the invention.

As shown in FIG. 19, a liquid container 1101A of the twelfth embodiment is different from the liquid container 1101 of the eleventh embodiment in that the on/off valve 37 for opening/closing the flow passage between the ink pack 7 and the ink detection unit 9 is provided on a side of the ink pack 7. Except that the position of the on/off valve 37 is changed, other parts are the same as those in the eleventh embodiment. The same parts are represented by the same reference numerals, and the descriptions thereof will be omitted.

In the liquid container 1101A of the twelfth embodiment, the ink detection unit 9 and the ink pack 7 are separable from each other, and the on/off valve 37 is provided in a flow passage 7c in the ink supply port 7b close to the ink pack 7 connected to the flow passage 9a of the ink detection unit 9.

In the liquid container 1101A of the twelfth embodiment, like the liquid container 1101 of the eleventh embodiment, since the ink detection unit 9 and the ink pack 7 are separable each other, the ink detection unit 9 is an independent part that has no relation with the provision of the on/off valve 37. Therefore, the use of an ink detection unit for a known liquid container that is not provided with the on/off valve 37 between the ink detection unit 9 and the ink pack 7 is possible, and the development of the liquid container 1101A becomes easy.

FIG. 20 shows a liquid container according to a thirteenth embodiment of the invention.

A liquid container 1101B of the thirteenth embodiment is different from the liquid container 1101 of the eleventh embodiment in that the on/off valve 37 for opening/closing the flow passage between the ink pack 7 and the ink detection unit 9 is added on a side of the ink pack 7. Except that the on/off valve 37 is added, other parts are the same as those in the eleventh embodiment. The same parts are represented by the same reference numerals, and the descriptions thereof will be omitted.

That is, the on/off valves 37 are provided in the flow passage 9a close to the ink detection unit 9 connected to the ink pack 7 and the flow passage 7c close to the ink pack 7 connected to the ink detection unit 9, respectively.

As such, if the flow passages 7c and 9a are provided in the ink pack 7 and the ink detection unit 9, respectively, ink or gas can be thoroughly prevented from flowing back to the ink pack 7 from the ink detection unit 9, and a degradation prevention performance of the degree of deaeration in the ink pack 7 can be further improved.

The structures of the liquid containing portion, the liquid detection unit, the liquid derivation portion, the on/off valve, and the like in the liquid container of the invention are not limited to the structures in the above-described embodiment, but various shapes can be used on the basis of the spirit of the invention.

For example, an ink detection unit for detecting the ink residual quantity in the ink pack 7 is not limited to the structure having the piezoelectric sensor 35 that applies the vibration to the ink guide path 33 and detects the free vibration state according to the vibration so as to detect the deformation of the diaphragm by the change in pressure due to the inflow of ink to the sensor chamber 21 , like the pressure detection unit 25 in the above-described embodiment.

An ink detection unit that has a contact sensor for directly detecting the deformation of the diaphragm to be deformed by the change in pressure due to the inflow of ink to the sensor chamber 21 so as to detect the ink residual quantity in the liquid container from a signal of the contact sensor may be used.

In a liquid container including the ink detection unit having such a structure, when the pressure by pressurized gas against the ink pack 7 is constant, if the ink residual quantity of the ink pack 7 becomes small, the derivation amount of ink to the ink detection unit decreases, the pressure in the ink detection unit decreases, and the diaphragm is deformed by the change in pressure at that time. Accordingly, the ink residual quantity in the liquid container can be detected by the contact sensor that detects the deformation of the diaphragm

In this case, the diaphragm that is likely to be deformed, according to the change in pressure of the ink detection unit may also be used. Then, the residual quantity detection precision can be improved, and, since the on/off valve blocks between the ink pack 7 and the ink detection unit, ink or gas can be prevented from flowing back from the ink detection unit having a low gas barrier property to the ink pack 7 having a high gas barrier property.

In the liquid container of each of the embodiments of the invention, the on/off valve that opens/closes the flow passage between the liquid containing portion and the liquid detection unit is not limited to the check valve described in the embodiments. For example, an on/off valve that opens/closes a valve body by an electromagnetic force may be used.

The use of the liquid container of the invention is not limited to an ink cartridge of an ink jet recording apparatus, but may be used as liquid containers corresponding to various liquid ejecting apparatus as a liquid container that can prevent degradation of a degree of deaeration of a stored liquid.

Specific examples of the liquid ejecting apparatus include, for example, an apparatus having a color material ejecting head used in manufacturing color filters of a liquid crystal display or the like, an apparatus having an electrode material (conductive paste) ejecting head used in forming electrodes of an organic electroluminescent (EL) display or a surface mission display (FED), an apparatus having a bioorganic compound ejecting head used in manufacturing a bio-chip, an apparatus having a sample spraying head as a precision pipette, a printing apparatus or a microdispenser, and so on.

1. A liquid container comprising:
a liquid containing portion that is pressurized by a pressure unit and discharges a liquid stored therein through a liquid discharge port;
a liquid supply port that supplies the liquid to an external liquid consuming apparatus; and
a liquid detection unit that is interposed between the liquid containing portion and the liquid supply port,
wherein the liquid detection unit includes:
a liquid detection chamber that has a liquid inlet port to be connected to the liquid discharge port of the liquid containing portion and a liquid outlet port to be connected to the liquid supply port;
a movable member that is movably accommodated in response to a liquid containing amount of the liquid detection chamber;
a recess portion that partitions a detection space in cooperation with one surface of the movable member when the liquid containing amount of the liquid detection chamber becomes a predetermined amount or less, and
a piezoelectric detection unit that applies vibration to the recess portion and detects a free vibration state according to the applied vibration, and wherein
the movable member is provided with two flow passages that connect the detection space partitioned with the cooperation of the recess portion to the liquid detection chamber.

2. The liquid container according to claim 1,
wherein one of the two flow passages extends to the vicinity of the liquid outlet port.

3. The liquid container according to claim 1,
wherein one of the two flow passages extends to the vicinity of the liquid inlet port.

4. The liquid container according to claim 1,
wherein the two flow passages extend to the vicinity of the liquid outlet port and the vicinity of the liquid outlet port, respectively.

5. The liquid container according to claim 1,
wherein the liquid detection chamber is configured by sealing an opening formed at its upper surface with a film that is deformable according to the liquid containing amount, and
the piezoelectric detection unit is disposed at the bottom of the liquid detection chamber.

6. The liquid container according to claim 5,
wherein the movable member moves by the deformation of the film corresponding to a liquid containing amount of the liquid detection chamber.

7. The liquid container according to claim 6,
wherein the movable member is fixed to the film.

8. The liquid container according to claim 1,
wherein the movable member has, in a region facing a vibration surface of the piezoelectric detection unit, a surface substantially parallel to the vibration surface.

9. The liquid container according to claim 1,
wherein the movable member is urged by an urging unit in a direction in which the piezoelectric detection unit is disposed.

10. The liquid container according to claim 9,
wherein the urging unit is formed of an elastic member.

11. The liquid container according to claim 1,
wherein a time at which the movable member partitions the detection space in cooperation with the recess portion is set to a state where the liquid of the liquid containing portion is exhausted.

12. The liquid container according to claim 1,
wherein a time at which the movable member partitions the detection space in cooperation with the recess portion is set to a state where the liquid of the liquid containing portion is nearly exhausted.

13. The liquid container according to claim 1,
wherein the recess portion has two openings and, when the recess portion partitions the detection space in cooperation with the movable member, the two openings are connected to the two flow passages of the movable member.

14. The liquid container according to claim 13,
wherein, in at least a posture when the liquid is filled in the liquid detection chamber, even though the two openings of the recess portion do not have a difference in height, two openings on sides not connected to the recess portion at the two flow passages of the movable member are disposed to have a difference in height.

15. A liquid filling method comprising
providing the liquid container according to claim 1; and
filling a liquid in the liquid detection unit of the liquid container in a state where a difference in height between two openings on sides not connected to the recess portion at the two flow passages of the movable member is secured.

16. A liquid container comprising:
a liquid containing portion that is pressurized by a pressure unit and discharges a liquid stored there in from a liquid discharge port;
a liquid supply port that supplies the liquid to an external liquid consuming apparatus; and
a liquid detection unit that is interposed between the liquid containing portion and the liquid supply port,
wherein the liquid detection unit includes:
a liquid detection chamber that has a liquid inlet port to be connected to the liquid discharge port of the liquid containing portion and a liquid outlet port to be connected to the liquid supply port,
a movable member that moves in response to a liquid containing amount of the liquid detection chamber,
a recess that is provided in the movable member to partition a detection space in cooperation with a recess portion provided in the liquid detection chamber when the liquid containing amount of the liquid detection chamber becomes a predetermined amount or less, and
a piezoelectric detection unit that applies vibration to the recess portion and detects a free vibration state according to the applied vibration.

17. The liquid container according to claim 16,
wherein the recess is formed of a member having at least one elastic surface.

18. The liquid container according to claim 17,
wherein the elastic member is a film.

19. The liquid container according to claim 16,
wherein the recess is connected to the liquid detection chamber.

20. The liquid container according to claim 16,
wherein the recess has two flow passages that connect the recess portion to the liquid detection chamber.

21. The liquid container according to claim 16,
wherein the liquid detection chamber is configured by sealing an opening formed at its upper surface with a film that is deformable according to the liquid containing amount, and
the piezoelectric detection unit is disposed at the bottom of the liquid detection chamber.

22. The liquid container according to claim 21,
wherein the movable member moves by the deformation of the film corresponding to a change in liquid containing amount of the liquid detection chamber.

23. The liquid container according to claim 22,
wherein the movable member is fixed to the film.

24. The liquid container according to claim 16,
wherein the movable member has a surface that is, in a region facing a vibration surface of the piezoelectric detection unit, substantially in parallel with the vibration surface.

25. The liquid container according to claim 16,
wherein the movable member is urged in a direction in which the piezoelectric detection unit is disposed.

26. The liquid container according to claim 25,
wherein the urging unit is formed of an elastic member.

27. The liquid container according to claim 16,
wherein a time at which the recess partitions the detection space in cooperation with the recess portion is set to a state where the liquid of the liquid containing portion is exhausted.

28. The liquid container according to claim 16,
wherein a time at which the recess partitions the detection space in cooperation with the recess portion is set to a state where the liquid of the liquid containing portion is nearly exhausted.

29. A liquid container comprising:
a liquid containing portion in which a liquid can be filled in advance at high degree of deaeration;
a liquid detection unit that has a gas barrier property lower than the liquid containing portion;
a liquid derivation portion that derives the liquid of the liquid containing portion to the outside through the liquid detection unit; and
an on/off valve that is provided in a flow passage between the liquid detection unit and the liquid containing portion so as to open/close the flow passage.

30. The liquid container according to claim 29r
wherein the on/off valve is a check valve that opens a flow of a derivation direction of the liquid to the outside, and closes a reverse flow.

31. The liquid container according to claim 29,
wherein the liquid detection unit and the liquid containing portion are separable from each other, and
the on/off valve is provided in a flow passage close to the liquid detection unit to be connected to the liquid containing portion.

32. The liquid container according to claim 29,
wherein the liquid detection unit and the liquid containing portion are separable from each other, and
the on/off valve is provided in a flow passage close to the liquid containing portion to be connected to the liquid detection unit.

33. The liquid container according to claim 29,
wherein the liquid of the liquid containing portion is pressurized by a pressure of pressurized air to be supplied from a pressurized gas injection portion and then is derived from a liquid supply portion to the outside, and
the liquid detection unit is disposed in a region that is blocked from a pressure of the pressurized gas, and includes a diaphragm that is deformed by a change in pressure due to an inflow of the liquid from the liquid containing portion and a detection mechanism that detects the deformation of the diaphragm.

34. The liquid container according to claim 29,
wherein the liquid detection unit is configured by sealing an opening of a recess portion provided in a member forming the liquid detection unit with a flexible film.

35. The liquid container according to claim 33,
wherein the diaphragm is urged by an urging member, which is elastically deformable by a pressure of the liquid flowing from the liquid containing portion, in a direction in which the volume of the liquid detection unit is reduced.

36. The liquid container according to claim 29,
wherein the liquid containing portion is a flexible pouch that is formed by attaching flexible films, and the films are multilayer films including an aluminum layer.

37. The liquid container according to claim 29,
wherein the liquid is ink.
